(19) United States
(12) Patent Application Publication
(10) Pub. No.: US 2005/0027386 A1
(43) Pub. Date: Feb. 3, 2005

(54) Decentralized project management system

(76) Inventors: Michele Weigand, Lawrence, KS (US); Deborah McLennan, Milwaukee, WI (US); John Coffey, Prairie Village, KS (US); Tsedenia Rabb, Overland Park, KS (US)

Correspondence Address: LEE & HAYES, PLLC, 421 W. RIVERSIDE AVE, STE 500, SPOKANE, WA, 99201, US

(21) Appl. No.: 10/631,705

(22) Filed: Jul. 30, 2003

(51) Int. Cl. G06F 17/60; G06F 19/00

(52) U.S. Cl. 700/97; 705/7; 705/8; 705/9; 700/100; 700/108; 700/99; 700/103; 700/105

(57) ABSTRACT

A decentralized project management framework may be implemented to manage process tasks defined by various functional organizations within a company. The determination of which process tasks are required for a particular type of project is managed by these functional organizations. In addition, parameters of a process task, such as examples, links, explanations and supporting documentation, may also be managed by these functional organizations. As such, responsibility for and access to such process tasks may be allocated to individual functional organizations using a plurality of function-specific datastores. Each function-specific datastore stores process tasks and related parameters. A tollgate site server presents a user interface allowing a user to enter input characterizing a project and retrieves process tasks from the various function-specific datastores according to the related parameters. The retrieved process tasks for the project can then be presented to the user for viewing, saving, or printing, through the user interface.

### TECHNICAL FIELD

The invention relates generally to project management frameworks, and more particularly to a decentralized project management system.

### DESCRIPTION

Project management generally refers to managing resources and process tasks to achieve a specified goal. For example, a project goal may be the introduction of a new product into a company's product portfolio. In order to achieve such a goal, various resources (e.g., money, personnel, facilities, etc.) are allocated, approved, trained, etc., and various process tasks are implemented. For one exemplary product, research and development personnel, training materials, and funds must be made available for developing, deploying, and supporting the proposed product. Likewise, prototyping, testing, support, training and other process tasks must be defined and scheduled in synchronization with the product development and release cycle.

In many project management frameworks, sequential stages of a project are defined as “tollgates”, which guide progress of the project in accordance with defined tollgate requirements. For example, a first tollgate (relating to initial development of the product) may include the required process tasks: “Obtain approval of initial product description”, “Obtain approval for development resources”, “Address product's expected impact on bottom line”, and “Obtain initial approval of prototype”. A second tollgate (relating to testing of the product) may include the required process tasks “Develop detailed field test plan”, “Obtain legal liability approval”, “Obtain approval for testing resources”, and “Obtain approval of testing results”. In a gated project management framework, the process tasks in the first tollgate are to be completed before the process tasks in the second tollgate are completed, or in some cases, even begun. In one implementation, the process tasks associated with one tollgate of a project represent a checklist of requirements that are to be completed before project tasks for the project's next tollgate are started.

For some projects or companies, individual functional organizations or departments (i.e., “functions”) may be deemed responsible for management of specific process tasks within one or more tollgates. In the example above, addressing the product's impact on the bottom line may be a requirement best managed by a finance function while evaluating legal liability may be a requirement best managed by a legal function.

In many projects, a central project management administrator uses project management tools (including software) to define the required process tasks and tollgates for various projects. As such, the process tasks relating to a given function (e.g., legal, finance, research) are typically managed in the project management framework by the central project management administrator, who receives input from the various supporting functions. From another perspective, within existing project management systems, personnel of individual functions do not directly manage process tasks defined by their functional organization. For example, if the finance department wishes to require a (new) additional level of authorization of expenditures over a certain threshold, the finance department does not provide this input directly into the project management system, but instead provides input to a central project management administrator, who updates the process tasks accordingly within the project management framework or tool.

A problem with this approach is that the central project management administrator is commonly not an expert of (or even a member of) the multitude of functional areas upon which projects may depend. Likewise, function members are not expert in the project management framework or tools used. Therefore, as requirements of a given function change, function members pass the changes along to the central project management administrator, who attempts to implement the new requirements within the project management framework.

As such, in existing approaches, the function members do not have direct control over their function's requirements within a project management framework. Furthermore, because the central project management is not an expert in the various functional areas, passing the new process tasks for a given function through the central project management administrator is both inefficient and susceptible to inadvertent errors.

Implementations described and claimed herein distribute responsibility for managing process tasks of a specific function to a functional owner, who is typically familiar with or expert in the process requirements of the function, in contrast to a central project management administrator of existing approaches. Functional owners, therefore, manage and control the process tasks (and the parameters of those process tasks) that are specified by their function. In this manner, function-specific requirements are effectively managed directly by the function itself, rather than a central project management administer.

In some implementations, articles of manufacture are provided as computer program products. One implementation of a computer program product provides a computer program storage medium readable by a computer system and encoding a computer program for project management. Another implementation of a computer program product may be provided in a computer data signal embodied in a carrier wave by a computing system and encoding the computer program for project management.

The computer program product encodes a computer program for executing on a computer system a computer process that receives user input characterizing a project within a project management framework. At least one process task from each of a plurality of function-specific datastores is accessed. Each function-specific datastore is associated with a functional area. Each process task is associated with at least one process parameter. A customized set of the process tasks is selected from the plurality of function-specific datastores. Each process task in the customized set is selected for the project if the at least one associated process parameter satisfies the user input.

In another implementation, a method is provided. User input characterizing a project within a project management framework is received. At least one process task from each of a plurality of function-specific datastores is accessed. Each function-specific datastore is associated with a functional area. Each process task is associated with at least one process parameter. A customized set of the process tasks is selected from the plurality of function-specific datastores. Each process task in the customized set is selected for the project if the at least one associated process parameter satisfies the user input.

In yet another implementation, another method and a computer program product provide that at least one process task and at least one associated process parameter is recorded in each of a plurality of function-specific datastores. Each process task and associated process parameter are specified by a user authenticated to access the function-specific datastore. A customized set of process tasks for a project characterized by a project type are collected from the function-specific datastores. At least one process parameter associated with each process task in the customized set satisfies the project type of the project.

In yet another implementation, a system is provided including a user interface receiving user input characterizing a project within a project management framework. A plurality of function-specific datastores is also provided. Each function-specific datastore is associated with a functional area and storing at least one process task and an associated process parameter. A tollgate site server accesses at least one process task from each function-specific datastores. The tollgate site server selects a customized set of the process tasks from the plurality of function-specific datastores. Each process task in the customized set is selected for the project if the at least one associated process parameter satisfies the user input.

In yet another implementation, system including a plurality of function-specific datastores is provided. Each function-specific datastore records at least one process task and at least one associated process parameter. Each process task and associated process parameter is specified by a user authenticated to access the function-specific datastore. A tollgate site server collects from the function-specific datastores a customized set of process tasks for a project characterized by a project type. At least one process parameter associated with each process task in the customized set satisfies the project type of the project.

In yet another implementation, one or more computer-readable media storing a data structure are provided. A first data field stores a process task definition associated with a first function. A second data field stores a process parameter associated with the first function. The process parameter associates the process task to one or more project types.

In another implementation, a tollgate site server collects a customized set of process tasks for a project characterized by a project type. Each process task is associated with at least one associated process parameter. Each process task and associated process parameter is specified by a user authenticated to define function-specific tasks. At least one process parameter associated with each process task in the customized set satisfies the project type of the project.

In another implementation, a user interface includes a first display area that receives guided user input to characterize a project. A second display area displays a customized set of process tasks for a project characterized by a project type, each process task being associated with at least one associated process parameter, each process task and associated process parameter being specified by a user authenticated to define function-specific tasks, wherein the at least one process parameter associated with each process task in the customized set satisfies the project type of the project.

Brief descriptions of the drawings included herein are listed below.

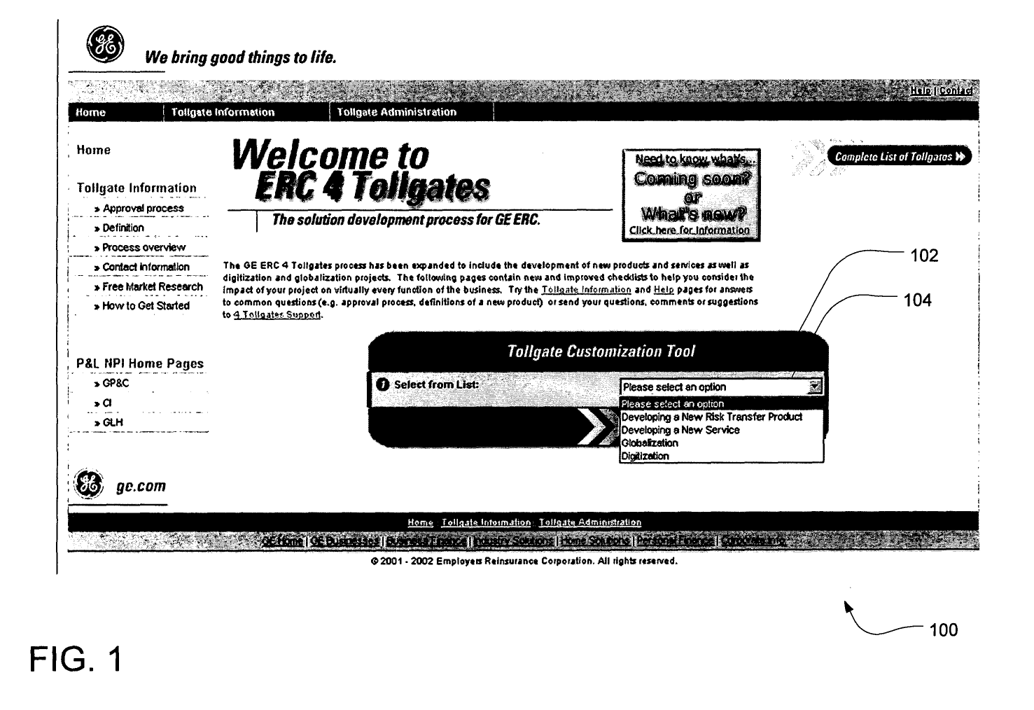

FIG. 1 illustrates a home page of a user interface to an exemplary decentralized project management system.

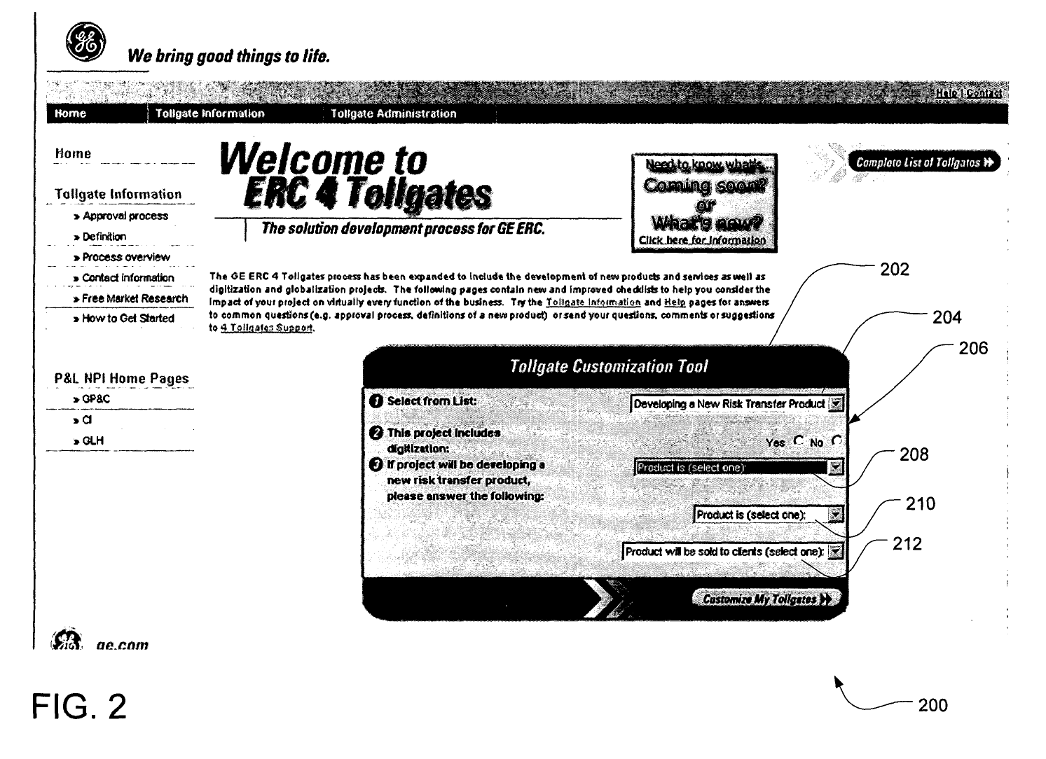

FIG. 2 illustrates a wizard page for capturing user input characterizing a project for introducing a risk-based product in an exemplary decentralized project management system.

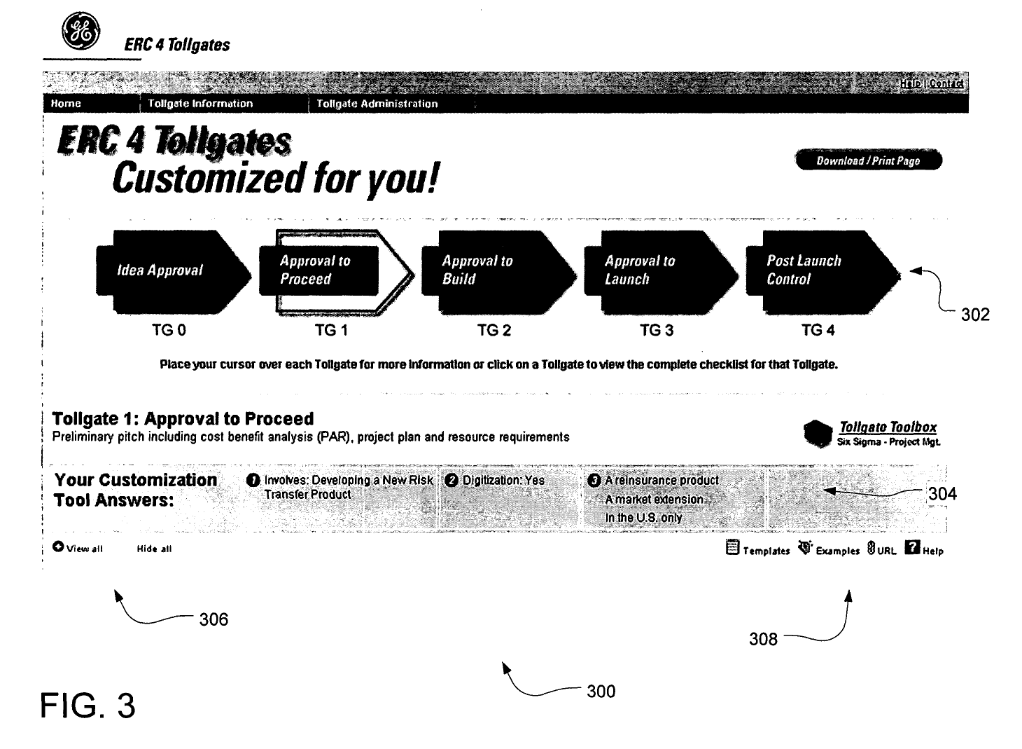

FIGS. 3-7 illustrate a first customized tollgate page for a characterized project in an exemplary decentralized project management system.

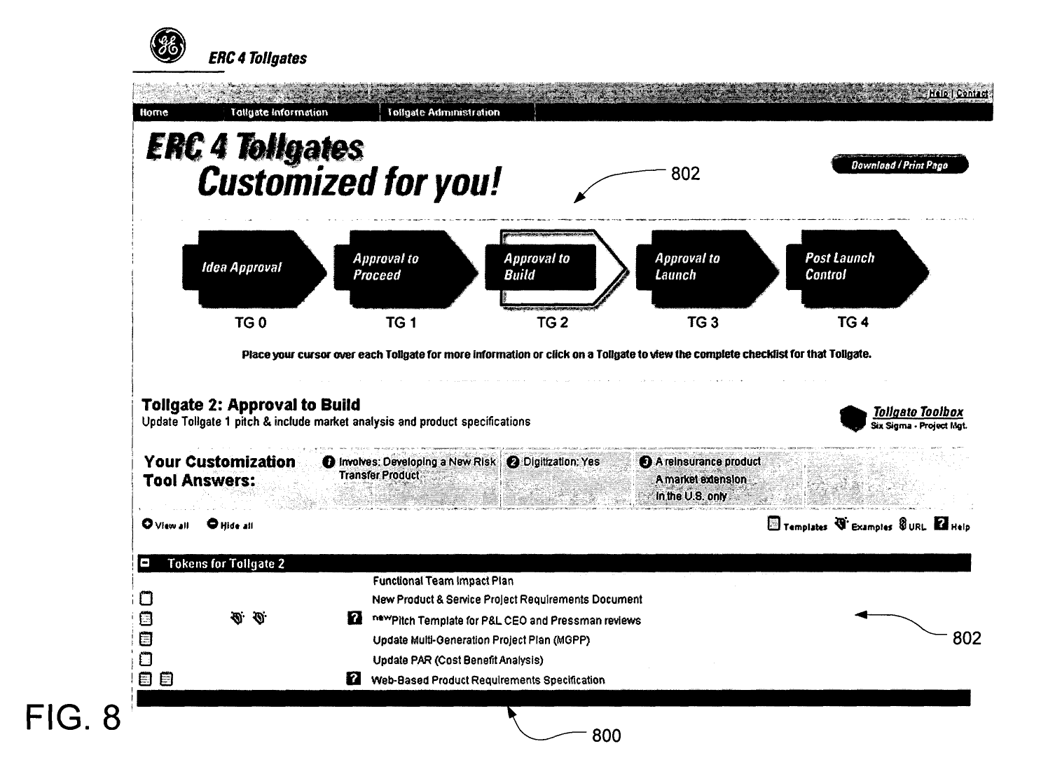

FIGS. 8-14 illustrate a second customized tollgate page for a characterized project in an exemplary decentralized project management system.

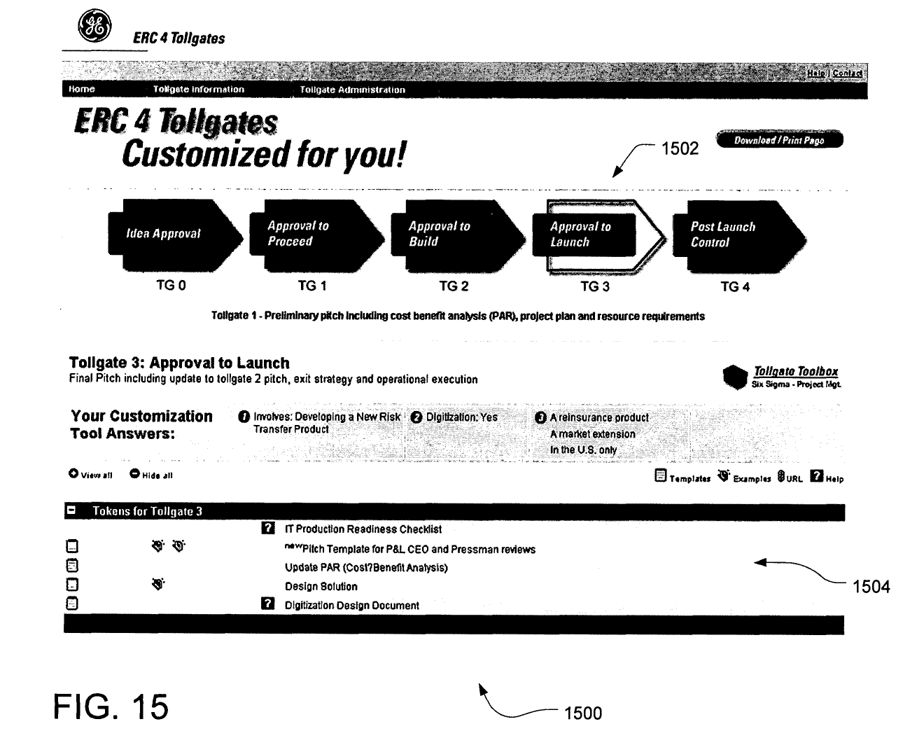

FIGS. 15-20 a third customized tollgate page for a characterized project in an exemplary decentralized project management system.

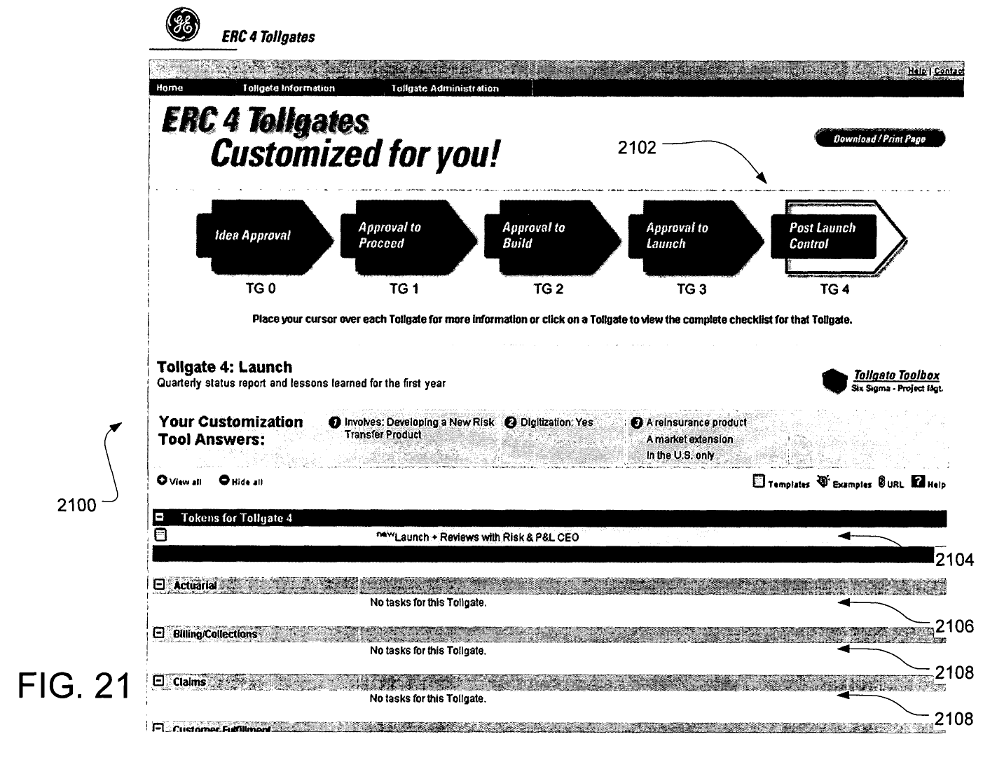

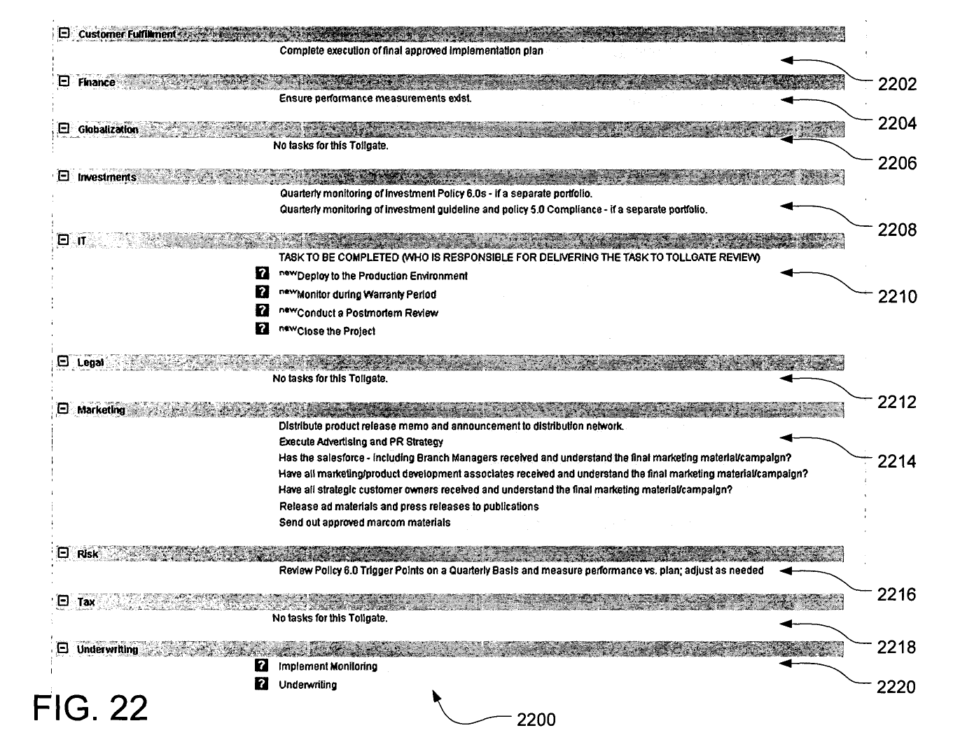

FIGS. 21-22 illustrate a fourth customized tollgate page for a characterized project in an exemplary decentralized project management system.

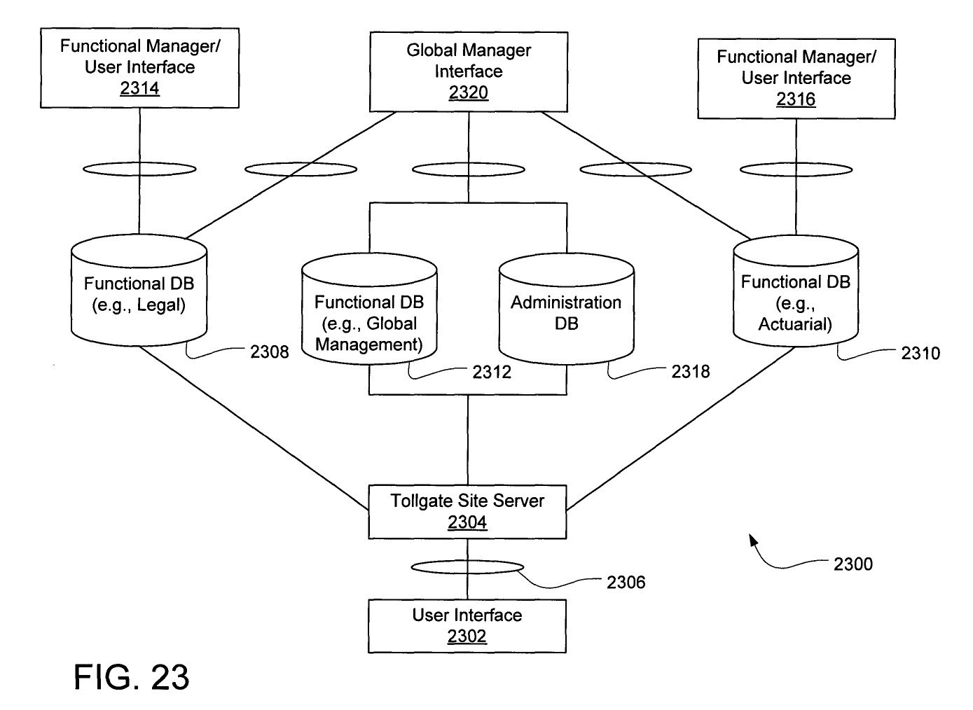

FIG. 23 illustrates an architecture of an exemplary decentralized project management system.

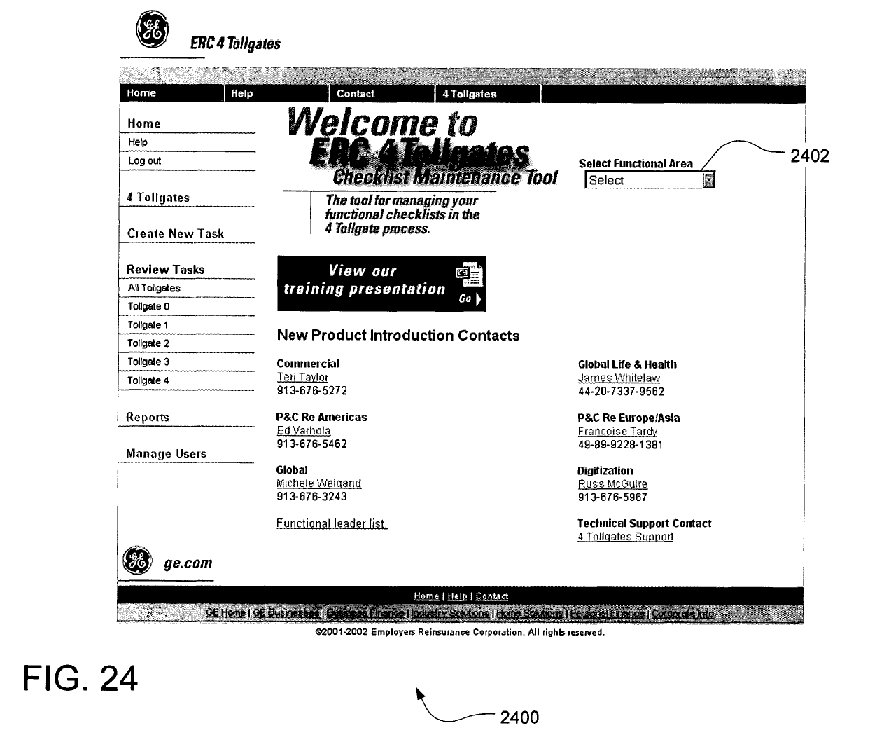

FIG. 24 illustrates a home page for a functional manager/user interface for an exemplary decentralized project management system.

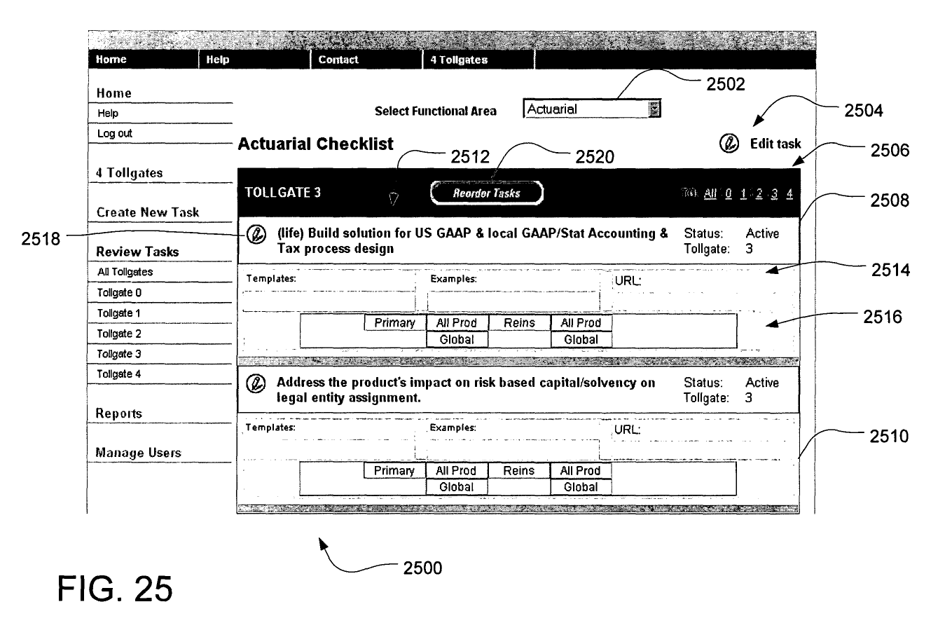

FIG. 25 illustrates a process task view page for a functional manager/user interface for an exemplary decentralized project management system.

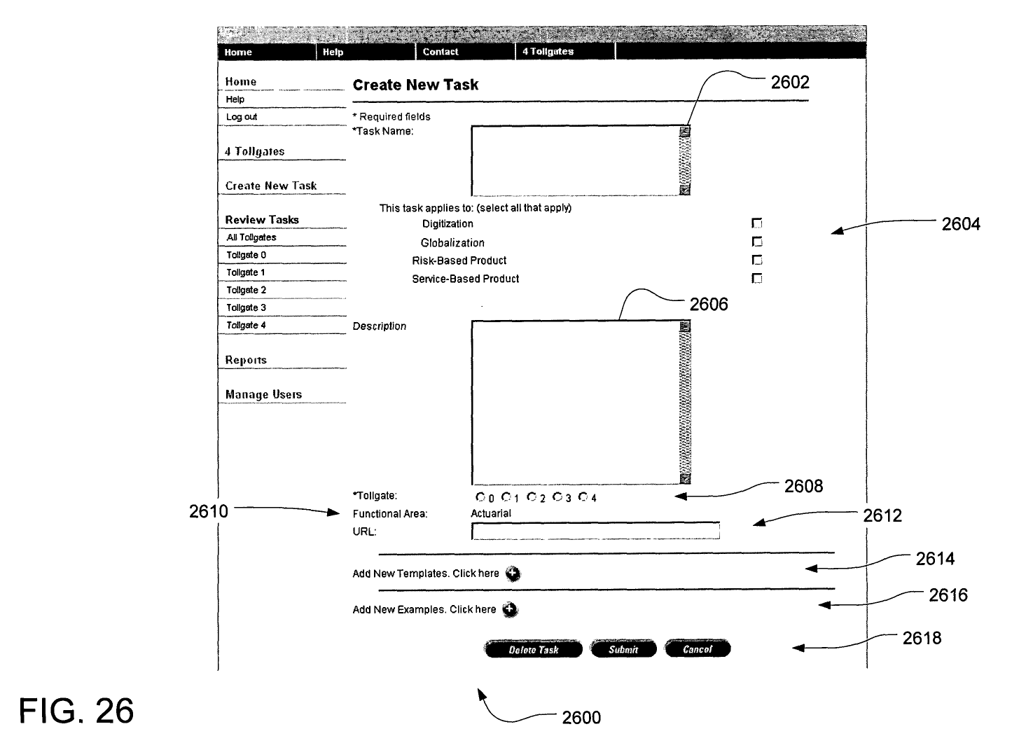

FIG. 26 illustrates a create new task page for a functional manager/user interface for an exemplary decentralized project management system.

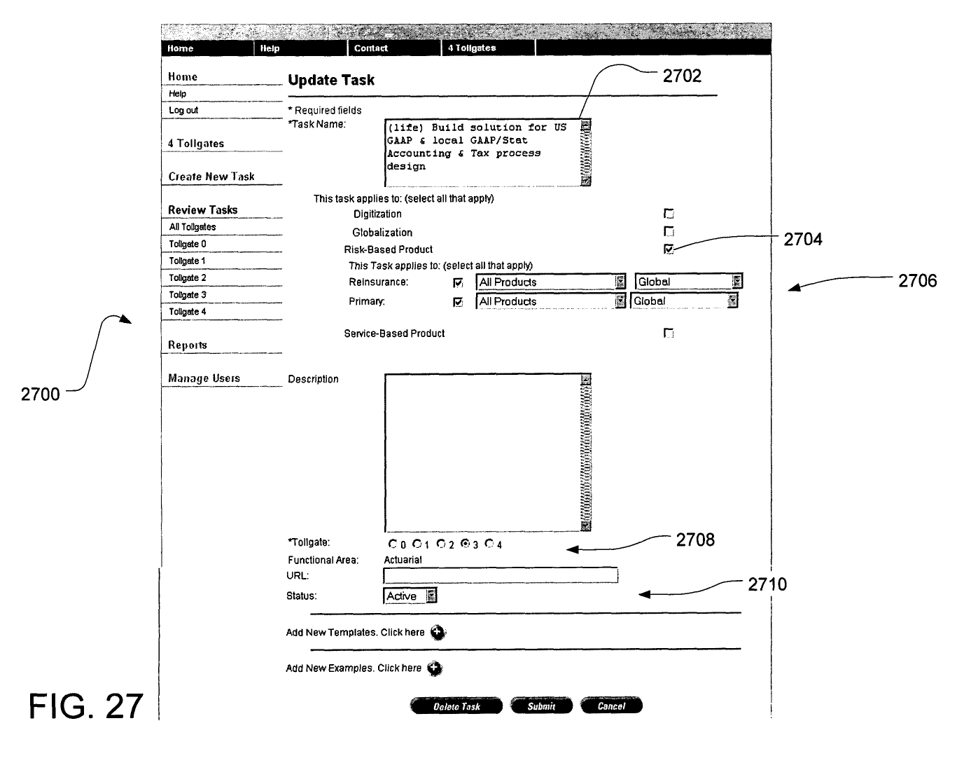

FIG. 27 illustrates an update task page for a functional manager/user interface for an exemplary decentralized project management system.

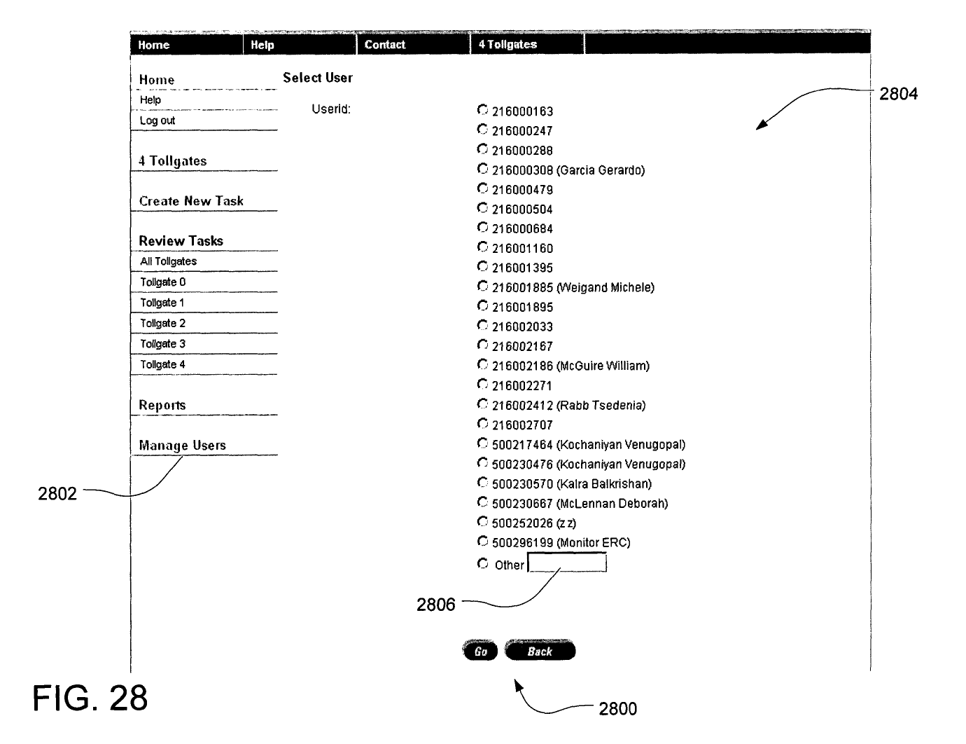

FIG. 28 illustrates a modify rights page for a functional manager/user interface for an exemplary decentralized project management system.

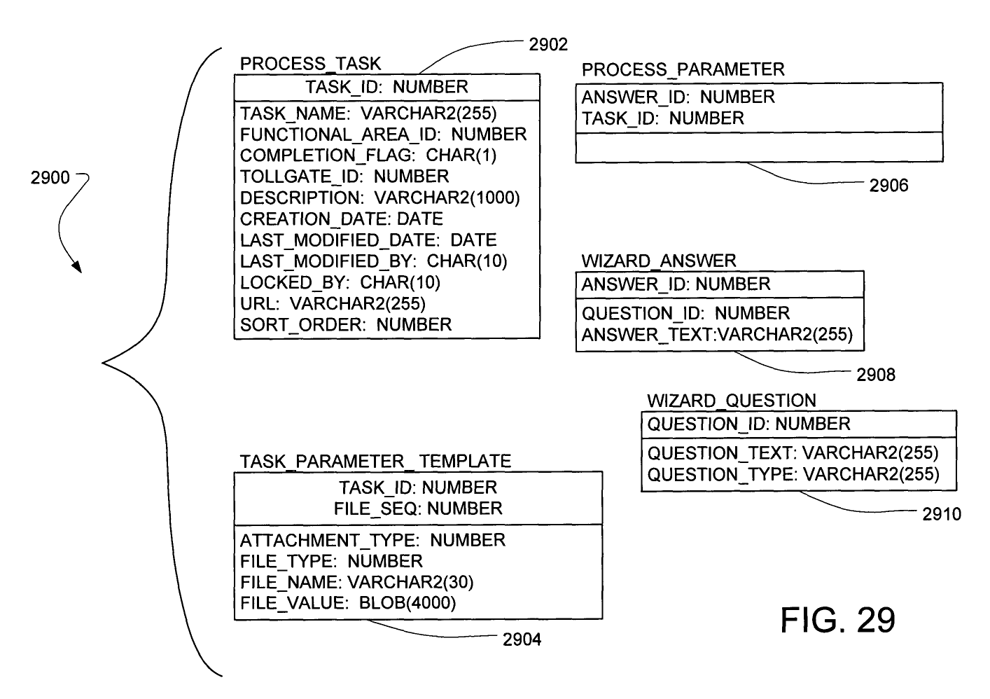

FIG. 29 illustrates a partial schema of an exemplary project management database system.

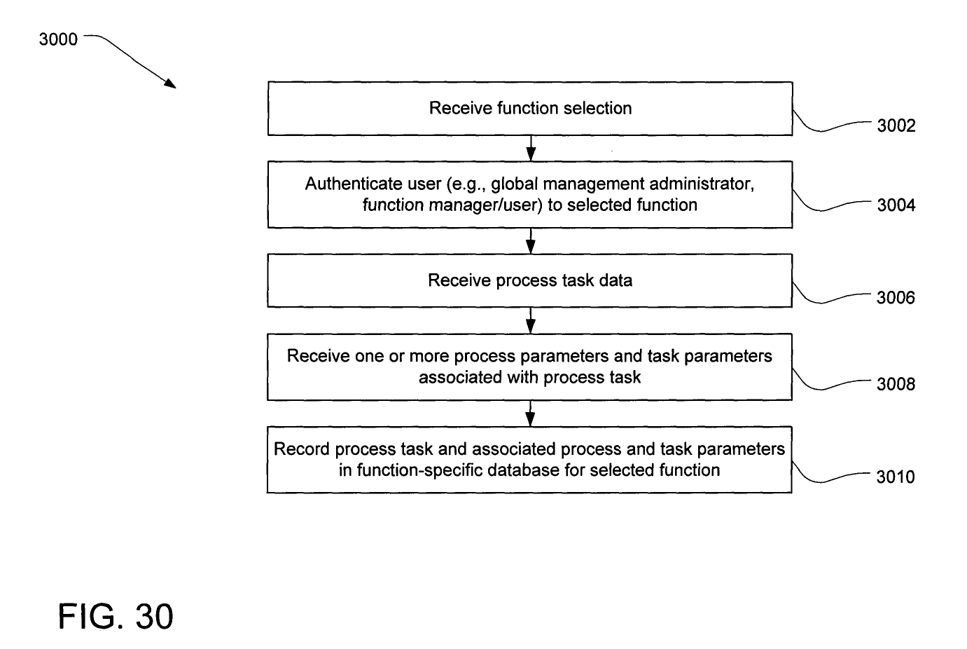

FIG. 30 illustrates exemplary operations for specifying process tasks for a function.

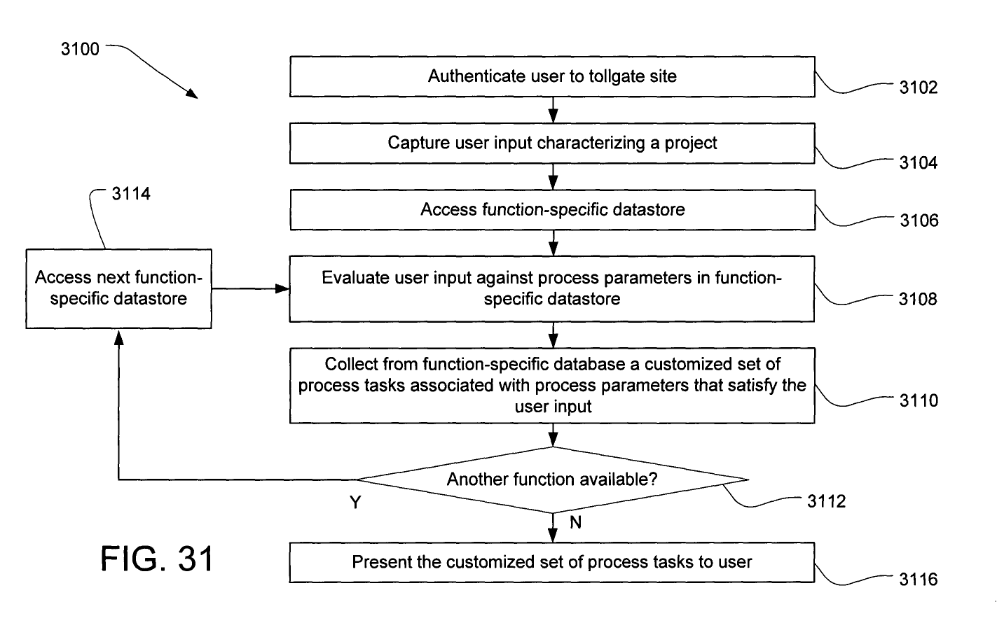

FIG. 31 illustrates exemplary operations for characterizing a project.

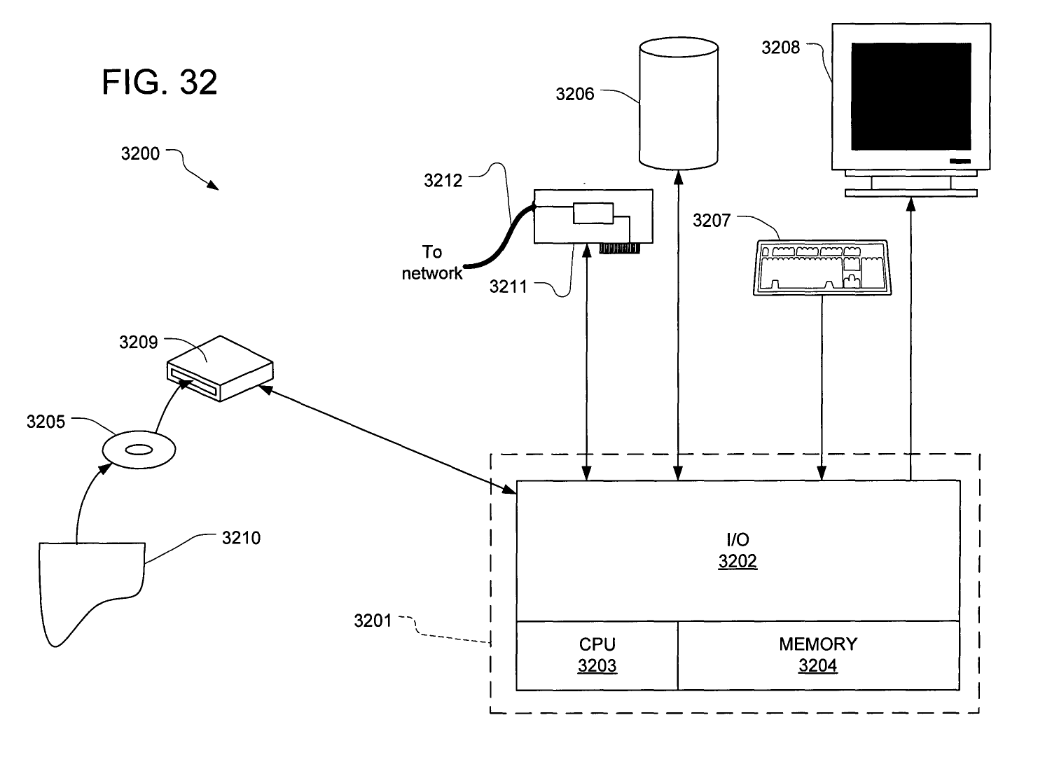

FIG. 32 illustrates an exemplary system useful for implementing an embodiment of the present invention.

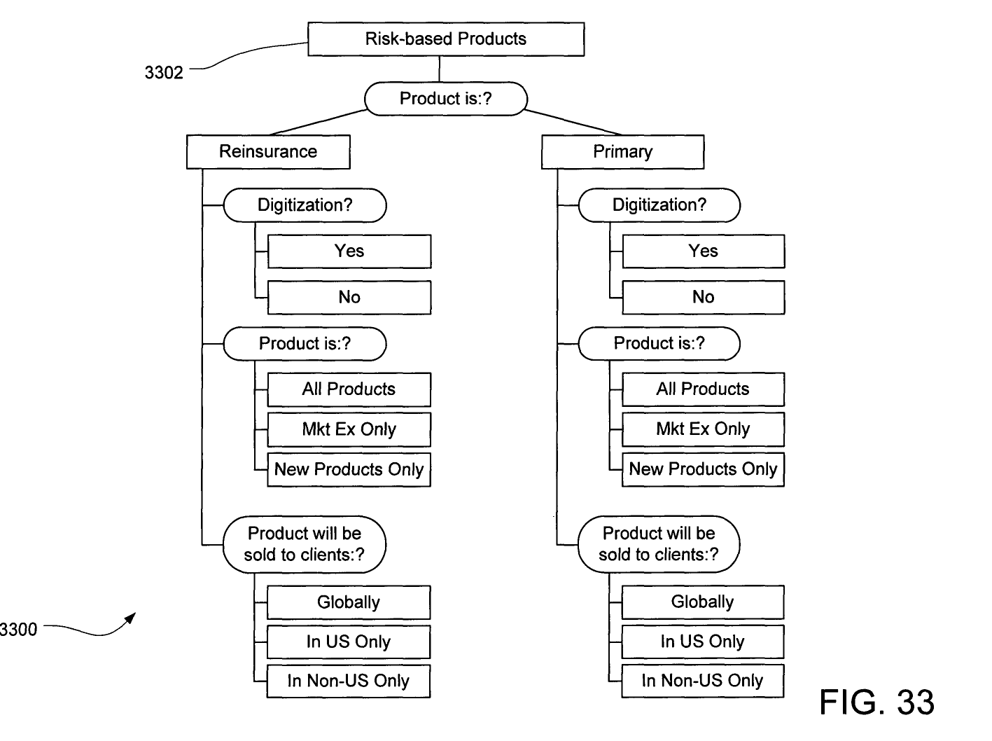

FIG. 33 illustrates exemplary questions and answers for risk-based products.

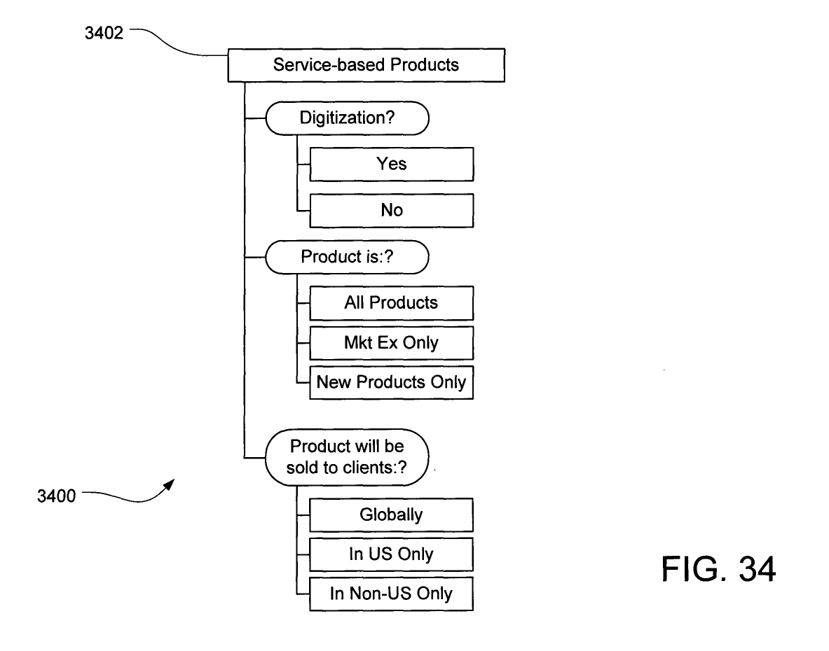

FIG. 34 illustrates exemplary questions and answers for service-based products.

Project management processes and techniques may be used in coordinating process tasks and resources to achieve predictable results for a given project. Many companies have adopted or developed detailed project management methodologies to assist in such planning. Often, such methodologies are embodied in a project management framework (e.g., a fairly enforced system of procedures, documentation, and approvals) and/or tool (e.g., a software program, management forms, metrics, etc.)

A project management framework may be implemented to manage process tasks defined by various functional organizations within a company. In such circumstances, the complete list of process tasks for a given project is dependent on the type of project and on the requirements of the various functions. For example, international projects may have specific international process tasks that are required, while domestic projects may not require completion of such tasks. Which process tasks are required for a particular type of project is managed by various functional organizations within the company, such as legal, finance, actuarial, billing/collections, marketing, etc. In addition, other parameters of a given process task, such as examples, explanations, and supporting documentation (e.g., forms, manuals), may also be managed by the various functional organizations. As such, responsibility for and access to such process tasks may be allocated (e.g., decentralized) within the described system to functional users within each of the functional organizations.

In one implementation, a decentralized project management system includes a plurality of function-specific datastores, each of which stores process tasks and related parameters managed by an individual functional organization (e.g., of a company, organization, government agency, etc.). A tollgate site server presents a user interface allowing a user to enter input data characterizing a project and retrieves process tasks from various function-specific datastores according to the related parameters. The retrieved process tasks for the project can then be presented to the user for viewing, saving, or printing through the user interface.

In one implementation, the goal of the project management system is to generate a tollgate checklist (i.e., a customized set) of process tasks that are to be 11 completed in a predefined sequence (e.g., within sequentially defined tollgates) in order to progress the project. In some implementations, the order in which process tasks are executed with a single tollgate is not enforced, monitored, or specified, although in other implementations, this order may be enforced, monitored and/or specified.

FIG. 1 illustrates a home page 100 of a user interface to an exemplary decentralized project management system. See the description of an architecture for an exemplary decentralized project management system relating to FIG. 23. Various navigation controls are shown along the top, bottom, and left side of the home page 100. These controls allow a user to navigate to help information, other company business sites, and other new product introduction (NPI) project management sites.

A tollgate customization tool 102 provides a wizard to assist the user's retrieval of project management information for a given product. In the illustrated drop-down box 104, four options are offered for characterizing the project: “Developing a New Risk Transfer Product”, “Developing a New Service”, “Globalization”, and “Digitization”. These exemplary selections contribute to characterizing different project types available in the illustrated implementation of the decentralized project management system.

In the illustrated example, the general project type of “Developing a New Risk Transfer Product” relates to life and health (primary) insurance and reinsurance, professional liability insurance, property and casualty insurance, commercial insurance, etc. If this option is selected, the user is taken to another page (see FIG. 2) for providing more detailed user input to further characterize the new risk-based produced introduction project. Another general project type, “Developing a New Service”, relates to insurance and reinsurance services, such as capital management services, underwriting, technical support, consulting services, etc. A third general project type, “Globalization” relates to moving all or part of an existing process to one or more other countries (e.g., to a lower cost country to save expenses of executing that process). A fourth general project type, “Digitization”, relates to digitizing an existing process (e.g., incorporating an existing, paper-based new product introduction process into the decentralized project management system). Other general project types are also contemplated. By selecting one of these options, the user may progress to a wizard page that is specific to the project type corresponding to the selected option. Generally, a wizard includes an interactive guide or prompt that assists the user with entering user input. It should be understood that non-interactive guides and other user input techniques may also be employed.

FIG. 2 illustrates a wizard page 200 for capturing user input characterizing a project for introducing a risk-based product in an exemplary decentralized project management system. Various navigation controls are shown along the top, bottom, and left side of the wizard page 200.

A tollgate customization tool 202 provides a wizard to capture (and guide) user input for refining the project type of the user's specified project. The selected general project type option (i.e., “Developing a New Risk Transfer Product”) is shown in drop-down box 204. If the general project type option is changed in the drop-down box 204, the appropriate wizard page for the newly selected general project type will be displayed. A pair of radio buttons 206 records whether the project type includes digitization (e.g., relating to tasks made or specified by an information technology group) A text box 208 captures a user selection relating to product characteristics (e.g., whether the product is an insurance product, a reinsurance product, or both). Another text box 210 captures a user selection relating to another aspect of product characteristics (e.g., whether the product represents a market extension of an existing product or a new product to the company or industry). Yet another text box 212 captures a user selection relating to another aspect of product characteristics (e.g., the geographical market of the customers buying the product). Each project type parameter input by the user may be evaluated against process parameters of the process tasks in the function-specific datastores to determine which process tasks are compiled into checklists for the user's project. For projects of type “Developing a New Service”, a wizard presents input options similar to those captured in text boxes 210 and 212 of FIG. 2. For other project types, the input options provided by the wizard may differ from those described above.

FIGS. 3-7 illustrate a first customized tollgate page 300 for a characterized project in an exemplary decentralized project management system. The customized tollgate pages are provided responsive to the capture of user input that characterizes a project. FIG. 3 depicts a top portion of the page 300. Navigation controls 302 provide a convenient mechanism for navigating to each tollgate for the current project in the project management system. Tollgate 0 corresponds to an introductory page (not shown) that explains to the user that supervisor approval is required to initiate a new project, providing a “pitch” template to facilitate obtaining such approval.

The first tollgate (i.e., Tollgate 1) corresponds to obtaining an initial approval to proceed with new product introduction, and involves a preliminary “pitch” to one or more functional organizations that includes a cost-benefit analysis, a project plan, and resource requirements. Generally, Tollgate 2 corresponds to obtaining approval to develop the product, a Tollgate 3 corresponds to obtaining approval to release the product, and Tollgate 4 corresponds to providing post release support for the product. It should be understood, however, that project management frameworks based on other methodologies (e.g., those with a greater number or a fewer number of tollgates, those without tollgates, etc.) may be employed within the described system.

The label 304 displays the user input provided by the user to characterize the current project. In one embodiment, the user input was collected by way of a wizard in the user interface, although alternative means of collecting user input may be employed, including without limitation receiving user input data from a database or another Web resource to characterize a current project. A legend 306 indicates the function of view/hide controls within the page 300.

Another legend 308 indicates the function of template, example, link, and help controls within the page 300. Generally, templates, examples, links, and help controls are referenced as task parameters associated with individual process tasks in the function-specific datastores. A template provides access to a document (e.g., an approval form, a procedure manual, etc.) that may be used in completing a process task. An example control provides access to an example document or resourced useful in completing the process task, such as a form populated with example data. A link control provides a link to a Web resource (e.g., a uniform resource locator or URL) that may be useful in completed the process task. A help control provides help data specific to the current process task. By selecting controls that are associated with a given task in the page 300, a user may access the corresponding information to assist in completing the task.

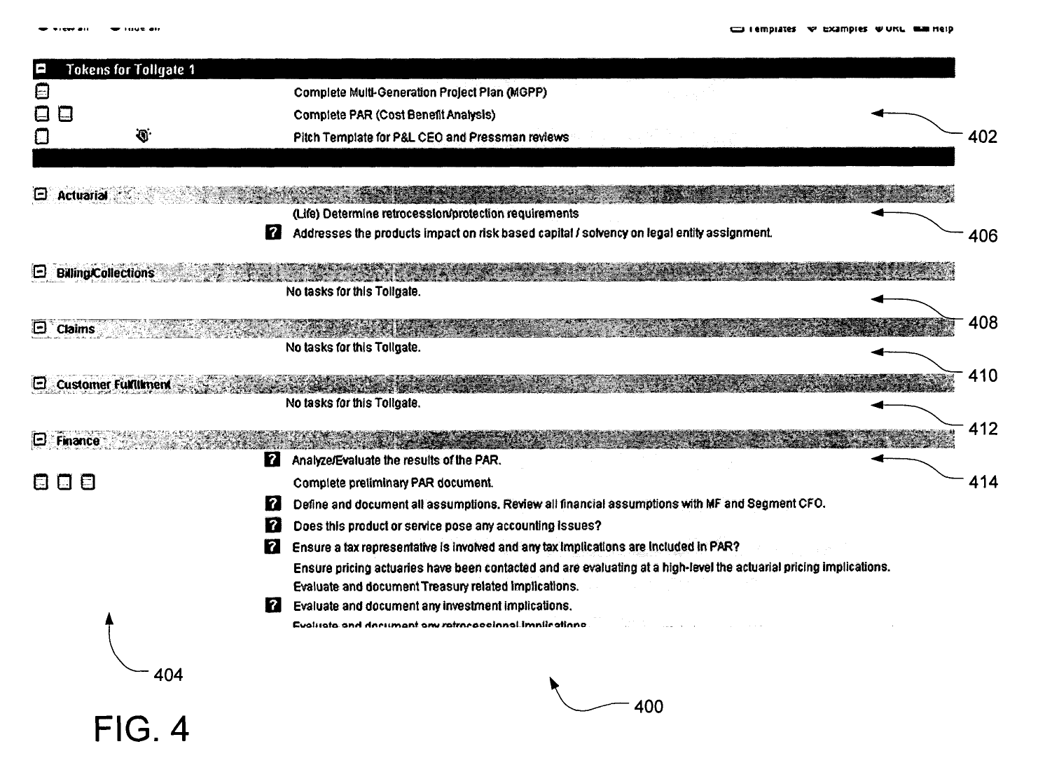

FIG. 4 illustrates a second portion 400 of the page 300. It should be understood that the multiple portions described in individual Figures may be shown on the display concurrently with each other or may be accessed by way of navigation (e.g., following links and controls) or scrolling. A tokens section 402 includes three process tasks that have been inserted into the process management framework at the first tollgate for projects of this project type. These tokens are not managed by an individual functional organization within the company but are considered a part of the project management framework itself. As such, tokens are managed by a global administrator and may not generally be added, deleted or modified by functional organization personnel. As designated by the template controls in the left most column, the three tokens are associated with templates by virtue of task parameters stored in the tokens datastore. Selecting one of the template controls will provide the user with access to a document template useful in completing one of the process tasks. In addition, the third token is also associated with an example. Selecting example control will provide the user with access to an example (e.g., a example populated form) useful in completing the process task of the third token.

Under the tokens section, multiple function-specific sections of the page 300 are listed. Each section is labeled with a function name 404 and includes process tasks corresponding to the labeled function. For example, for Tollgate 1, the actuarial function has defined two process tasks—“(Life) Determine retrocession/protection requirements” and “Addresses the products impact on risk-based capital/solvency on legal entity assignment”. The second process task is associated with a help control. The process task and parameters are stored in a function-specific datastore managed by a functional user from the functional organization (e.g., the Actuarial Department).

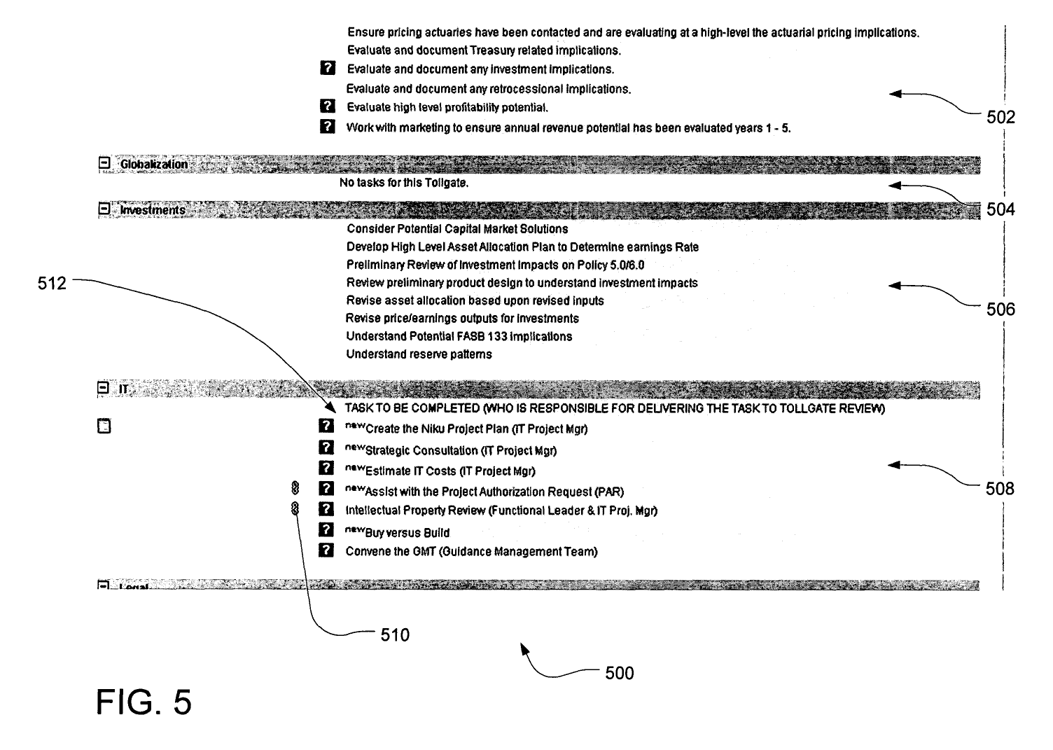

Other function sections 408, 410, and 412 (for Billings/Collections, claims, and Customer Fulfillment, respectively) are also included in the page 300. However, for Tollgate 1, no process tasks are defined by these functions. A function section 414 for Finance is illustrated with multiple process tasks and continued in FIG. 5. Some process tasks in the Finance section are associated with templates and other help controls to facilitate completion of the process tasks used therein.

FIG. 5 illustrates a third portion 500 of the page 300, continuing at 502 the Finance function section 414 from FIG. 4. A Globalization function section 504 does not include any process tasks for Tollgate 1. An Investments function section 506 includes several process tasks. An IT (information technology) function section 508 also includes process tasks, some of which are associated with link parameters. If the user selects the link control 510, for example, the user will access a Web resource at a specified URL associated with the process task “Intellectual Property Review (Functional Leader & IT Proj. Mgr)”.

In one implementation, a “New” flag 512 is displayed for a predetermined period of time (e.g., 60 days) after the associated process task is first input or subsequently modified in the functional database. This flag 512 alerts the user to new process requirements. In an alternative implementation, the flag 512 may be displayed for a predetermined number of accesses by the user (e.g., using cookies for monitor the user accesses) or for some other limiting time-related or access-related characteristic.

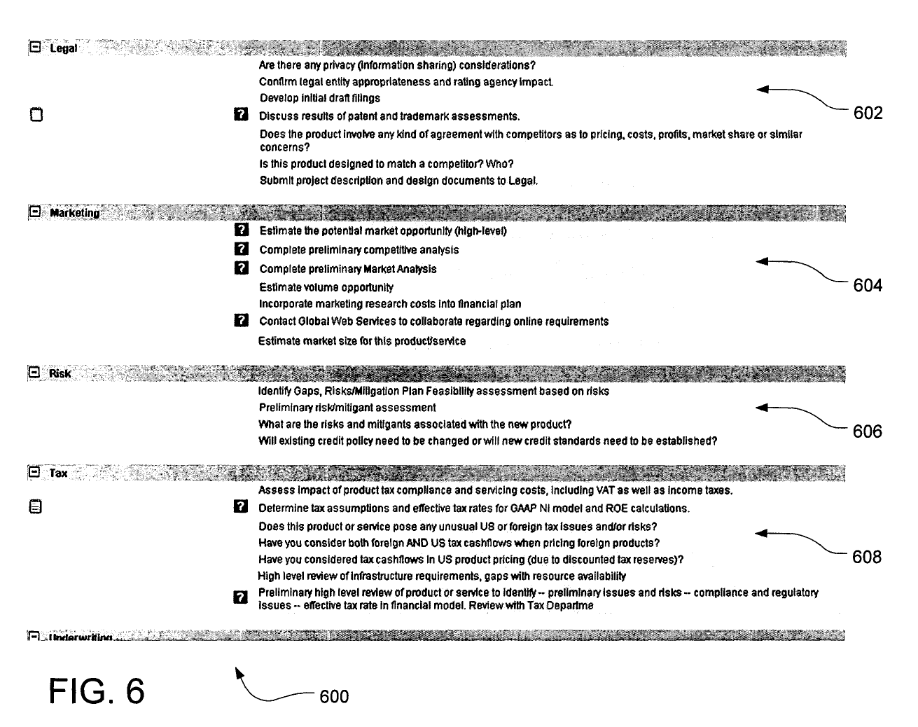

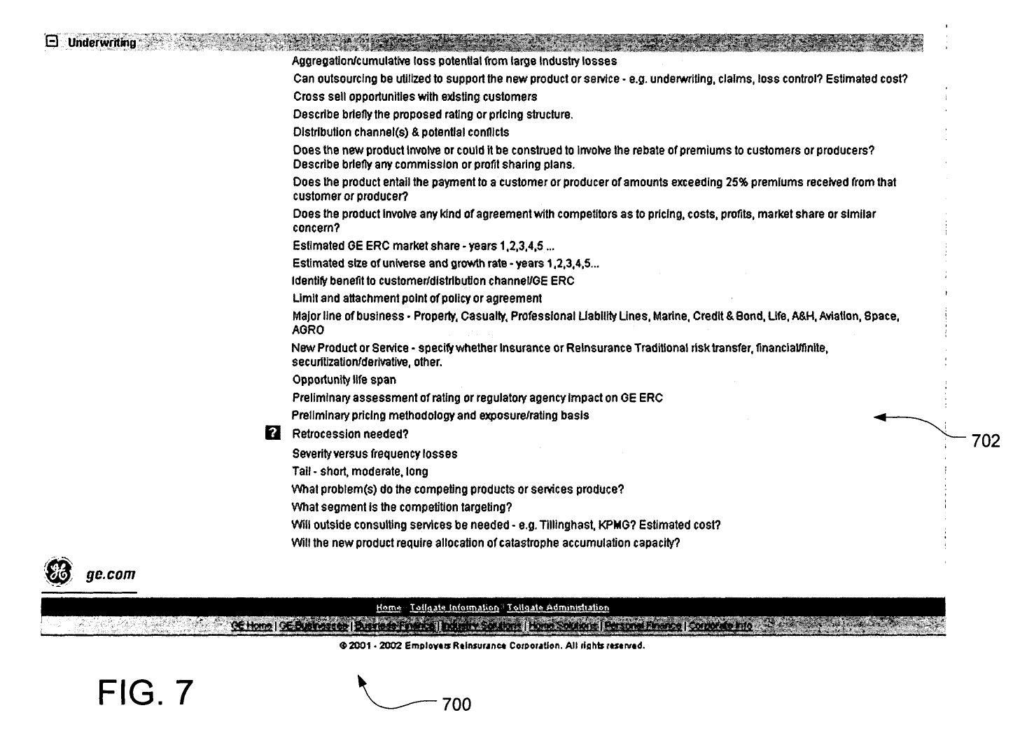

FIGS. 6-7 illustrate fourth and fifth portions of the page 300. FIG. 6 shows a page portion 600 that includes function sections for Legal (602), Marketing (604), Risk (606), and Tax (608). FIG. 7 shows a page portion 700 that includes a function section for Underwriting (602).

FIGS. 8-14 illustrate a second customized tollgate page 800 for a characterized project in an exemplary decentralized project management system. FIG. 8 depicts a top portion of the page 800. The second tollgate (i.e., Tollgate 2), as indicated in the tollgate sequence at 802, corresponds to obtaining an approval to proceed with development of the new product, and involves updating the preliminary “pitch” from Tollgate 1, and preparing a market analysis and product specifications. A tokens section 804 includes six process tasks that have been inserted into the process management framework at the second tollgate for projects of this project type.

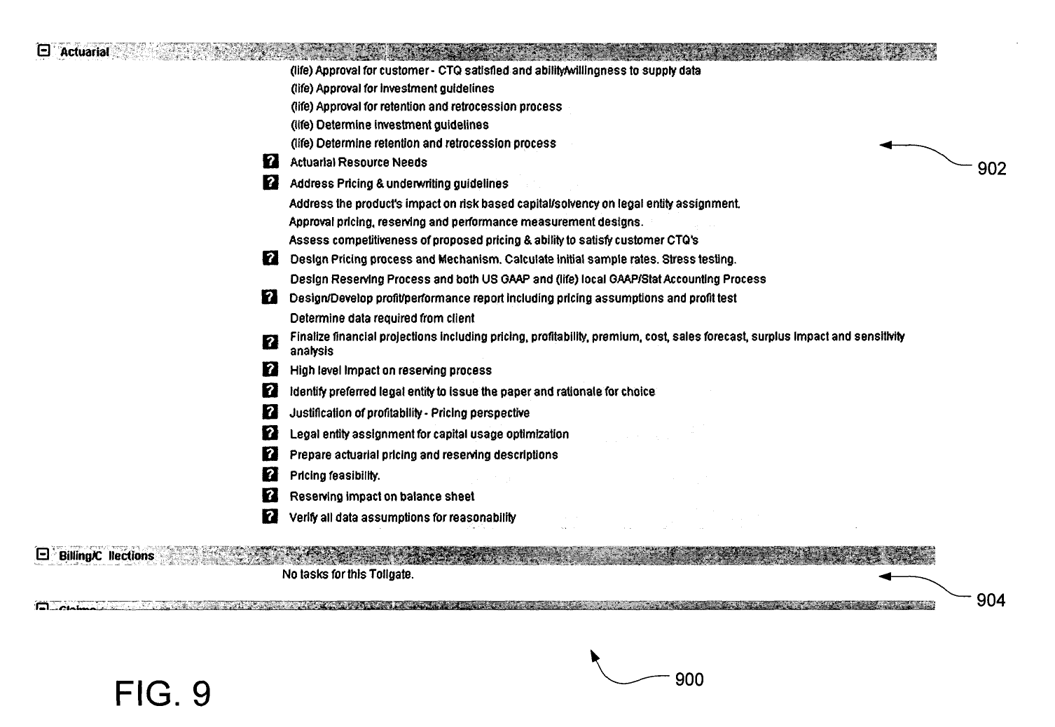

FIGS. 9-14 illustrate other portions of the page 800 that include various function-specific sections. It should be understood that different process tasks from different functions are listed in page 800, as compared to page 400, by virtue of the process parameters specified in each function-specific datastore. Likewise, various controls, such as template, example, link, and help controls are associated with each process task by virtue of task parameters specified in each function-specific datastore.

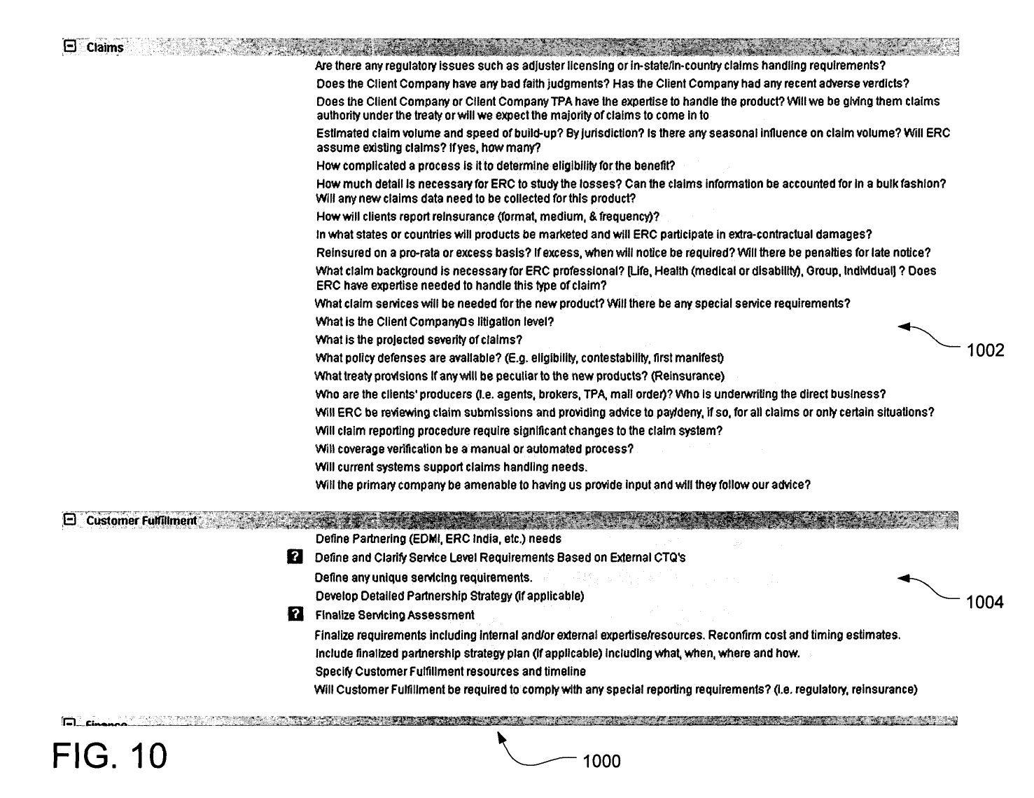

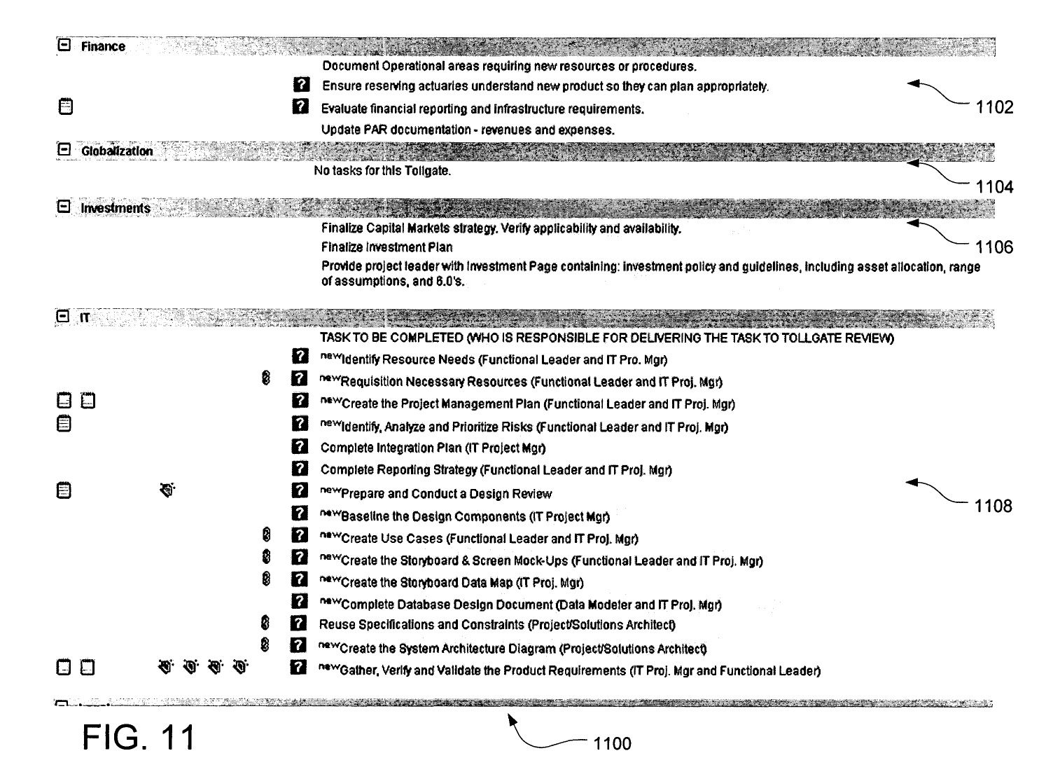

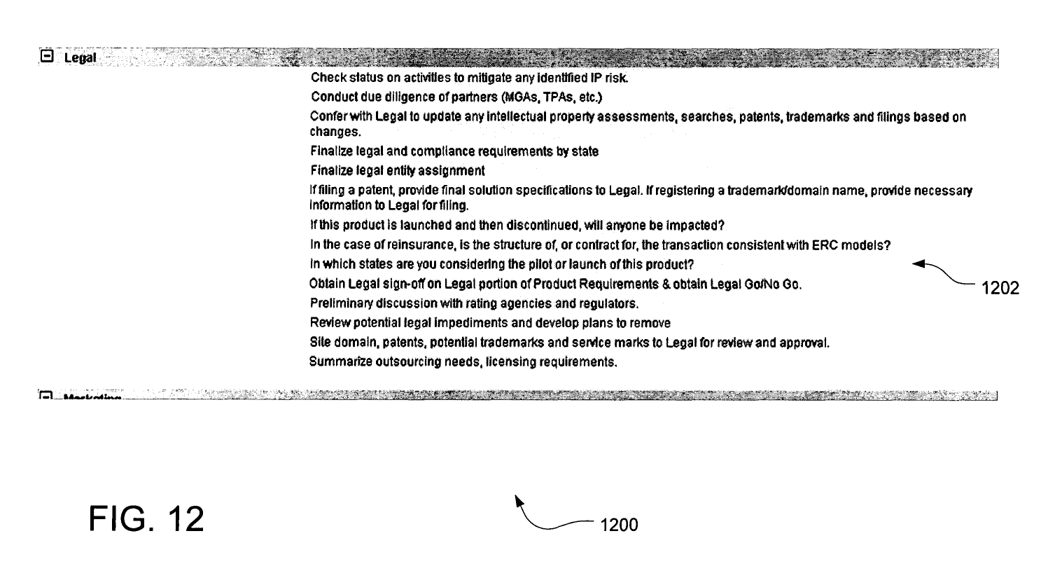

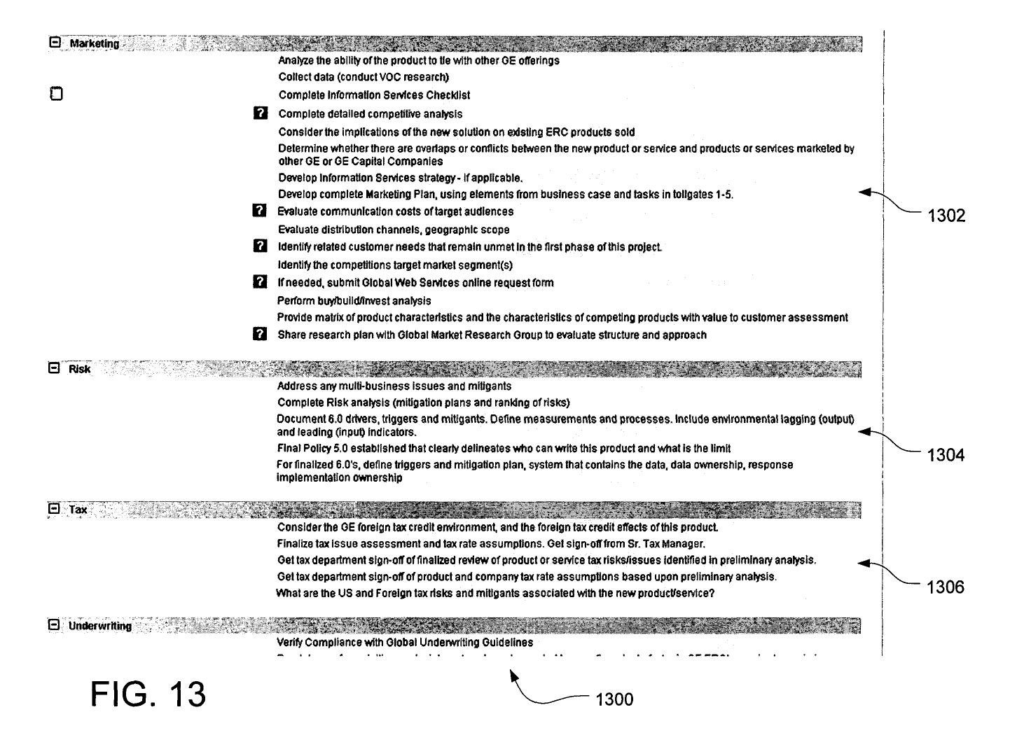

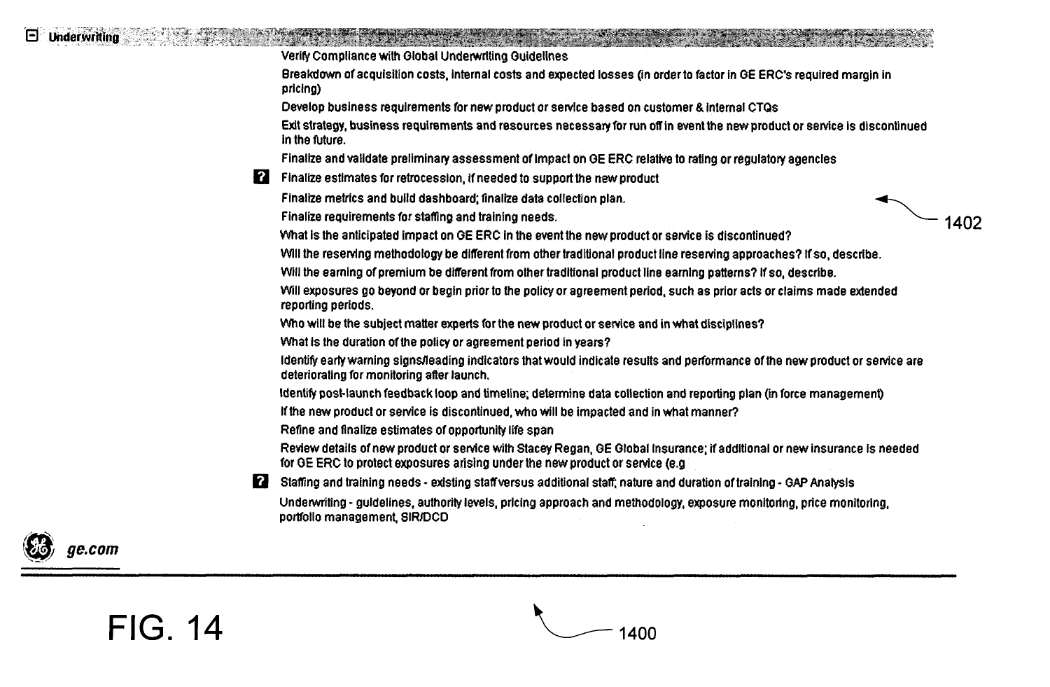

FIG. 9 illustrates a portion 900 of the page 800 including function-specific sections for Actuarial (902) and Billing/Collections (904). FIG. 10 illustrates a portion 1000 of the page 800 including function-specific sections for claims (1002) and Customer Fulfillment (1004). FIG. 11 illustrates a portion 1100 of the page 800 including function-specific sections for Finance (1102), Globalization (1104), Investments (1106), and IT (1108). FIG. 12 illustrates a portion 1200 of the page 800 including a function-specific section for Legal (1202). FIG. 13 illustrates a portion 1300 of the page 800 including function-specific sections for Marketing (1302), Risk (1304), and Tax (1306). FIG. 14 illustrates a portion 1400 including a function-specific section for Underwriting (1402).

FIGS. 15-20 a third customized tollgate page 1500 for a characterized project in an exemplary decentralized project management system. FIG. 15 depicts a top portion of the page 1500. The third tollgate (i.e., Tollgate 3), as indicated in the tollgate sequence at 1502, corresponds to obtaining an approval to launch the new product, and involves updating the “pitch” from Tollgate 2 to create a Final Pitch, preparing an exit strategy and executing the product launch. A tokens section 1504 includes five process tasks that have been inserted into the process management framework at the third tollgate for projects of this project type.

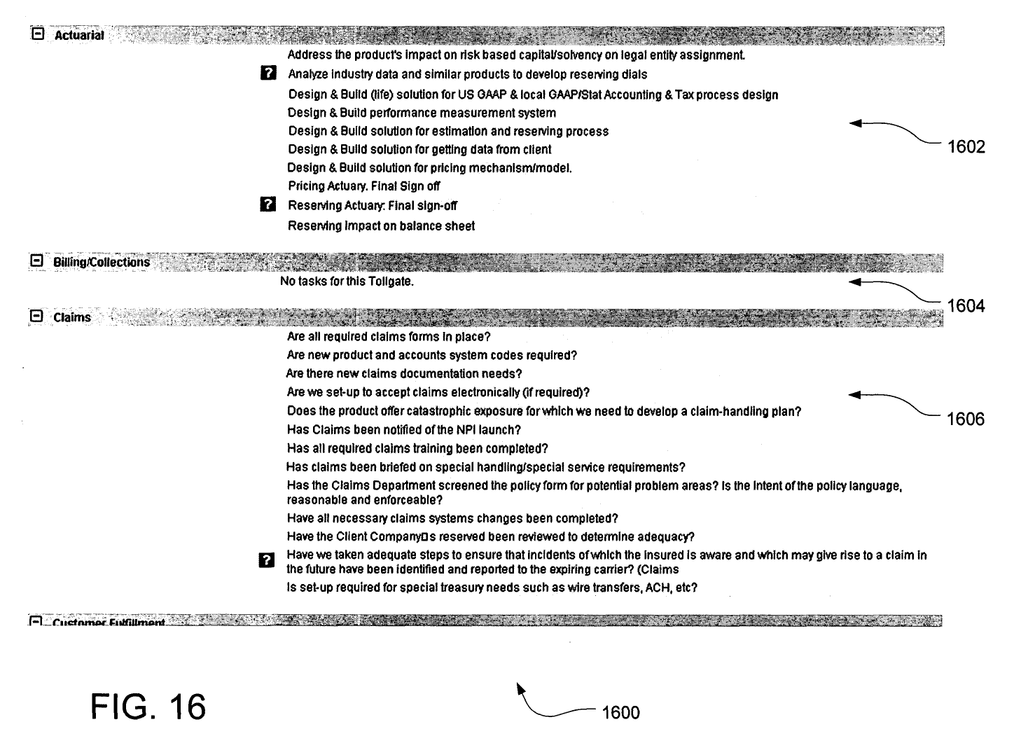

FIGS. 16-20 illustrate other portions of the page 1500 that include various from different functions are listed in page 1500, as opposed to pages 400 and 800, by virtue of the process parameters specified in each function-specific datastore. Likewise, various controls, such as template, example, link, and help controls are associated with each process task by virtue of task parameters specified in each function-specific datastore.

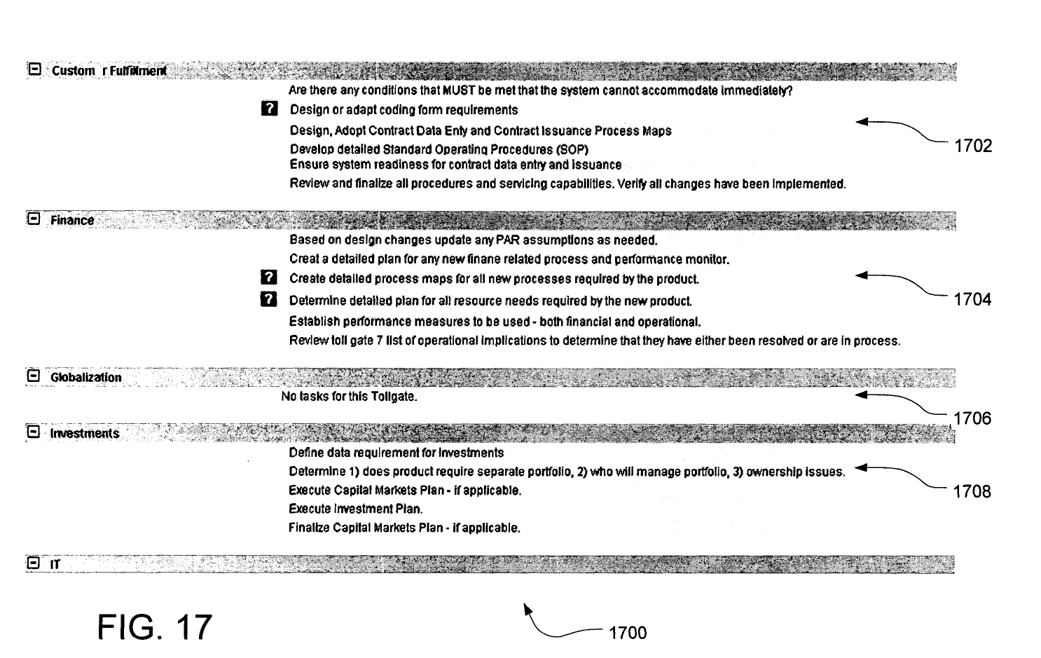

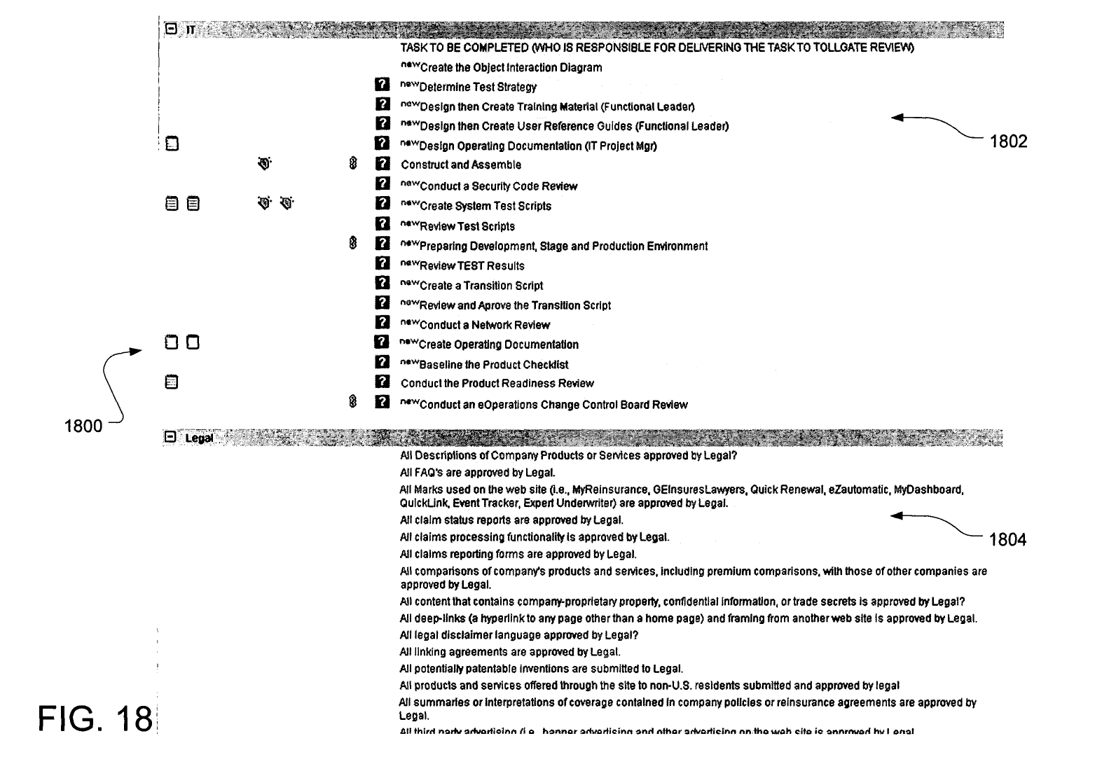

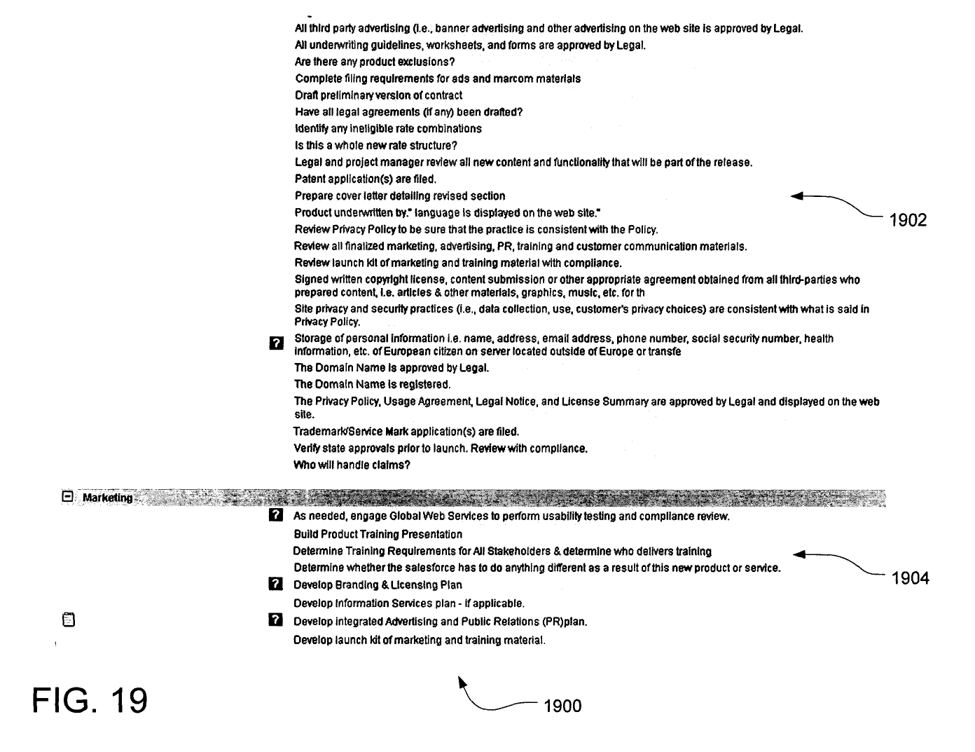

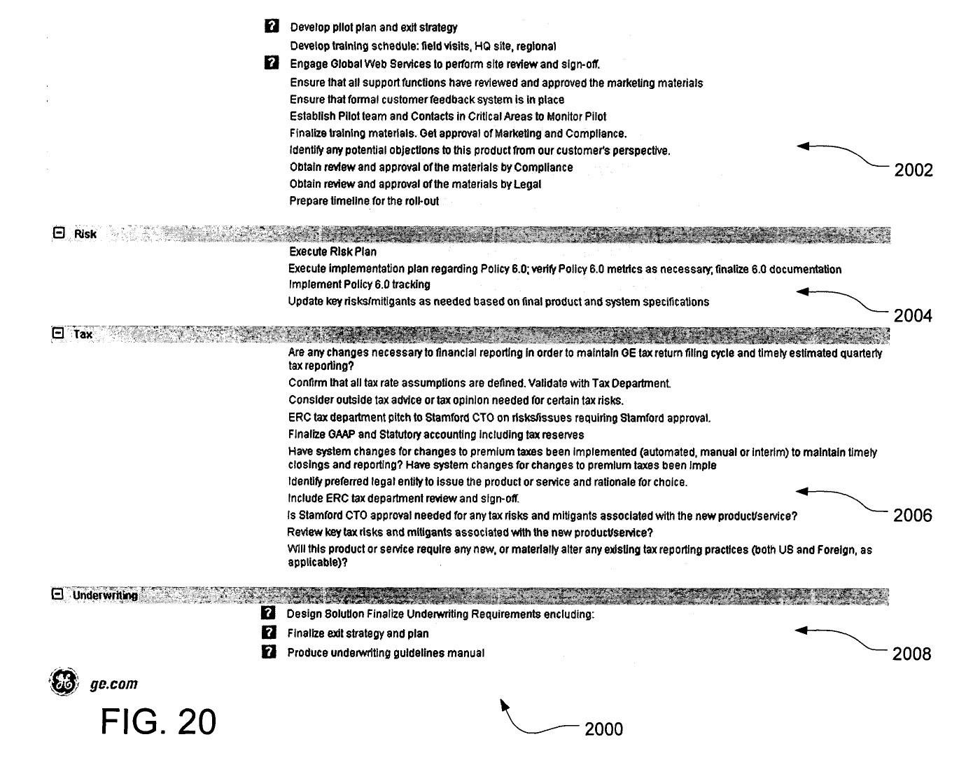

FIG. 16 illustrates a portion 1600 of the page 1500 including function-specific sections for Actuarial (1602), Billing/Collections (1604), and claims (1606). FIG. 17 illustrates a portion 1700 of the page 1500 including function-specific sections for Customer Fulfillment (1702), Finance (1704), Globalization (1706), and Investments (1708). FIG. 18 illustrates a portion 1800 of the page 1500 including a function-specific section for IT (1802) and a portion of the function-specific section for Legal (1804). FIG. 19 illustrates a portion 1900 of page 1500 including the remainder of the function-specific section for Legal (1902) and a portion of the function-specific section for Marketing (1904). FIG. 20 illustrates a portion 2000 of the page 1500 including the remainder of the function-specific section for Marketing (1302), as well as function-specific sections for Risk (2002), Tax (2004), and Underwriting (2006).

FIGS. 21-22 illustrate a fourth customized tollgate page 2100 for a characterized project in an exemplary decentralized project management system. FIG. 21 depicts a top portion of the page 2100. The fourth tollgate (i.e., Tollgate 4), as indicated in the tollgate sequence at 2102, corresponds to supporting the new product, and involves preparing quarterly status reports and evaluating and responding to lessons learned in the first year of the new product's release. A tokens section 2104 includes one process task that has been inserted into the process management framework at the fourth tollgate for projects of this project type.

The tollgate page 2100 also includes function-specific sections for Actuarial (2104), Billing/Collections (2106), and claims (2108). It should be understood that different process tasks from different functions are listed in page 2100, as opposed to pages 400, 800, and 1500 by virtue of the process parameters specified in each function-specific datastore. Likewise, various controls, such as template, example, link, and help controls are associated with each process task by virtue of task parameters specified in each function-specific datastore. FIG. 22 illustrates a portion 2200 of the page 2100 including function-specific sections for Customer Fulfillment (2202), Finance (2204), Globalization (2206), Investments (2208), IT (2210), Legal (2212), Marketing (2214), Risk (2216), Tax (2218), and Underwriting (2220).

FIG. 23 illustrates an architecture of an exemplary decentralized project management system 2300. A user interface 2302, such as that described with regard to FIGS. 1-22, is provided by a tollgate site server 2304. In one implementation, the server 2304 includes a Web server module serving the user interface through a Web browser, although other implementations are contemplated, such as providing a Web application to a client computer system (e.g., a handheld device or desktop computer) or providing textual or graphical output across a network to a dumb terminal.

If security is an issue, a user may be authenticated in order to gain access to the tollgate site, as represented by an authorization gateway 2306. Once authenticated, the user may provide user input, such as through a wizard, to characterize a desired project. Based on the user input, process tasks in a plurality of function-specific datastores, such as legal and actuarial databases (DBs) 2308 and 2310, are evaluated for inclusion in a customized set of process tasks for a characterized project. It should be understood that, while only two function-specific datastores are shown in FIG. 23, many more functions and function-specific datastores may be included the decentralized project management system.

Each function-specific datastore includes one or more process tasks managed by a corresponding functional organization. Each process task may be parameterized by a process parameter and/or a task parameter. A process parameter controls which projects (as characterized by user input) and tollgates include the associated process task. A task parameter controls which templates, examples, links, and help information are available for a given process task. The display of the various controls (e.g., template controls) in the user interface for a given process task is also controlled by the task parameter.

Function-specific datastores are managed by functional users in a functional organization, through a functional user interface, such as interfaces 2314 or 2316. Each interface requires authenticated access in order to create, delete, or modify process tasks, parameters, or user accounts. For example, legal department personnel may be granted functional user rights to add, delete, and modify process tasks and parameters in the legal database 2308. Such rights may be granted to an individual functional user by a functional manager (e.g., a functional user with the ability to create and manage functional user accounts for a specific function) or a global management administrator (e.g., an administrator with the ability to create other global management administrators, functional managers, and functional user accounts). The user accounts for these roles are stored in the functional database for the associated function, such as legal database 2308, or in an administration datastore, such as the administration database 2314. The discussion relating to FIG. 29 provides additional details of an exemplary process task data structure.

A function-specific datastore, such as Global Management database 2318, stores tokens for various project types. Generally, tokens are allocated to one or more tollgates for one or more project types. Tokens are not managed by a functional organization. As such, a global administration manager has authenticated access through the global management interface 2320 to the Global Management database 2312 and the Administration database 2318.

FIG. 24 illustrates a home page 2400 for a functional manager/user interface for an exemplary decentralized project management system. The functional manager/user interface allows a functional manager or user to manage (e.g., create, delete, modify, etc.) process tasks and parameters for a given functional organization. Functional managers have added rights to manage (e.g., create, delete, modify, etc.) functional user accounts. When a functional manager or user logs into the functional manager/user interface, the functions for which he or she is authorized to access are listed in the drop down box 2402. Typically, a single functional manager or user is limited to a single function, although, in alternative embodiments, a single functional manager or user may be given access to multiple functions.

FIG. 25 illustrates a process task view page 2500 for a functional manager/user interface for an exemplary decentralized project management system. Once a functional manager/user has been authenticated and has selected (or been granted access to) a function-specific datastore, the manager/user may choose to view process tasks for one or more tollgates using the navigation controls on the left side of the page. FIG. 25 shows process tasks designated by an actuarial function for tollgate 3. The function associated with these process tasks is shown in drop down box 2502. A legend 2504 indicates the “Edit task” control. Navigational links 2506 allow a user to navigate to process tasks for other tollgates or for all tollgates.

Two process tasks, tasks 2508 and 2510, are visible in FIG. 25, although more may be viewed by scrolling the browser window. For the process task 2508, the process task title is shown at 2512. The task parameters for templates, examples, and links are shown at 2514. (No task parameters are associated with the process task 2508.) The process parameters for the process task 2508 are shown at 2516.

If a functional manager/user wishes to edit a process task for his or her function, he or she may selected the edit control, such as edit control 2518, which will display an edit task page. In addition, a reorder tasks button 2520 may be selected to display a reordering page (not shown), thereby allowing the functional manager/user to move individual process tasks up and down in the process task display order.

FIG. 26 illustrates a create new task page 2600 for a functional manager/user interface for an exemplary decentralized project management system. A global management administrator interface may also provide such a page. A Task Name field 2602 receives a name for the process task, such as “(Life) Determine retrocession/protection requirements” for the process task 2508 in FIG. 25. Various process parameters selectors 2604 can be selected, which may result in the user interface changing to prompt follow-up information (see, e.g., parameters 2706 in FIG. 27). A description field 2606 may be populated by the functional manager/user to provide help text or other descriptive information. A process parameter 2608 allows the functional user/manager to specify the tollgate to which the process task is associated. A label 2610 specifies the functional area that manages the process task.

A link task property 2612 allows the functional/manager to specify one or more URLs for Web resources associated with the process task. A template task property tool 2614 allows the functional/manager to specify one or more template files associated with the process task (e.g., by opening a browse window into the file system). An example task property tool 2616 allows the functional/manager to specify one or more example files associated with the process task. A button set 2618 allows the functional manager/user to delete the current task, save the current task, or cancel creation of a new task. Example process task data is illustrated in an update task page 2700, shown in FIG. 27.

FIG. 27 illustrates an update task page 2700 for a functional manager/user interface for an exemplary decentralized project management system. A global management administrator interface may also provide such a page. The fields and controls in the update task page 2700 are similar to those shown in create task page 2600. Task name field 2702 initially shows the current title of the process task, which may be edited by the functional manager/user. Task parameters selectors include a selected Risk-based Product checkbox 2704. Responsive to selection of the Risk-based Product checkbox 2704, selectors for process parameters 2706 are display for input by the functional manager/user. The process parameters refine the project type to determine the customized set of process tasks selected for a given project based on the user input. Logic for implementing an exemplary wizard and for compiling process tasks from multiple functional databases according to user input is discussed with regard to FIGS. 33 and 34.

The current process task is designated for tollgate 3, according to selectors 2708. The status 2710 of the current process task is set for “active”, allowing the process task to be selected into a customized set of process tasks for a given project. If the status is set to “inactive”, the process task would remain in the function-specific datastore, but it would not be eligible for inclusion in a customized set.

FIG. 28 illustrates a modify rights page 2800 for a functional manager/user interface for an exemplary decentralized project management system. A global management administrator interface may also provide such a page. A global administrator or functional manager/user may navigate to the modify rights page 2800 by selecting the Manage Users control 2802. A user, as specified by a user identifier, may be selected from the list 2804. In response to a selection, the global administrator or functional manager/user is taken to a page for modifying the rights of the selected user. By selecting the “Other” item and entering a new user identifier, the global administrator or functional manager/user may insert another user into the system and provide them with appropriate rights. Users may also be deleted by appropriate administrators using the Manage Users page sequence (e.g., FIG. 28).

FIG. 29 illustrates a partial schema 2900 of an exemplary project management database system. A PROCESS_TASK database table 2902 is keyed by a TASK_ID field and represents a process task definition. The process task definition includes a task parameter field, represented by the URL field that references a resource. Another task parameter field is represented by the DESCRIPTION field in the PROCESS_TASK database table 2902. Yet another task parameter field in the illustrated partial schema is represented by the TASK_PARAMETER_TEMPLATE database table 2904, which is also keyed by the TASK_ID field so that its data is associated with the data a corresponding PROCESS_TASK database table 2902.

A PROCESS_PARAMETER database table 2906 operates as a process parameter field that links individual process tasks to required user input entries (e.g., answers input through the wizard). The answers are stored in the WIZARD_ANSWER database table 2908 and the corresponding question is stored in the WIZARD_QUESTION database table 2910. Using logic discussed with regard to FIGS. 33 and 34, for example, a set of user input for a given is evaluated against the answers associated with a given process task to determine whether the process task should be collected and displayed to the user for the project.

FIG. 30 illustrates exemplary operations 3000 for specifying process tasks for a function. A receiving operation 3002 receives a selection of a function (e.g., legal, actuarial, etc.). The functions that are available for selection are dictated by the rights allocated the user (e.g., global management administrator, functional manager, or functional user) and the user's authentication. For example, a global management administrator is likely to have rights to all or many functions, while a functional user is likely to have rights to only one function. A “token” function may also be managed by a global management administrator. An authentication operation 3004 authenticates and authorizes the user, if the user has rights to access the function-specific datastore associated with the selected function.

Another receiving operation 3006 receives a data defining a process task, such as through a “create new task” or “modify task” page. Another receiving operation 3008 receives at least one process parameter to control the placement of the process task in the project management process. The receiving operation 3008 may also receive zero or more task parameters, which specify resources such as files, Web resources, and other information to assist in completing the associated process task. In some implementations, receiving operations 3006 and 3008 are performed through a single page, although other implementations may split the operations into multiple pages. In addition, the receiving operations 3006 and 3008 may include a deletion of or modification to an existing process task in the datastore. A recording operation 3010 records the process task and the associated parameters into a function-specific database corresponding to the selected function.

FIG. 31 illustrates exemplary operations 3100 for characterizing a project. A user accesses a tollgate site and is authenticated in an authentication operation 3102. In a capture operation 3104, a tollgate customization tool receives user input that characterizes the project the user is interested in planning.

Based on the captured user input, an access operation 3106 accesses a function-specific datastore, which in one implementation is managed by a functional organization. An evaluation operation 3108 evaluates the user input against process parameters in the function-specific datastore. The process tasks associated with process parameters that satisfy the user input captured in capture operation 3104 are selected in collection operation 3110.

A decision operation 3112 determines whether another function is available to the project management system. If so, an access operation 3114 accesses the next function specific datastore and proceeds to the evaluation operation 3108. If not, the customized set of process tasks selected in the collection operation 3110 is presented to the user for viewing, saving, or printing.

FIG. 32 depicts an exemplary general purpose computer capable of executing a program product. One operating environment in which the described system is potentially useful involves the general purpose computer, such as shown as computer 3213. In such a system, data and program files may be input to the computer, including without limitation by means of a removable or non-removable storage medium or a data signal propagated on a carrier wave (e.g., data packets over a communication network). The computer 3213 may be a conventional computer, a distributed computer, or any other type of computing device.

The computer 3213 can read data and program files, and execute the programs and access the data stored in the files. Some of the elements of an exemplary general purpose computer are shown in FIG. 32, wherein a processor 3201 is shown having an input/output (I/O) section 3202, at least one processing unit 3203 (e.g., a microprocessor or microcontroller), and a memory section 3204. The memory section 3204 may also be referred to as simply the memory, and may include without limitation read only memory (ROM) and random access memory (RAM).

A basic input/output system (BIOS), containing the basic routines that help to transfer information between elements within the computer 3213, such as during start-up, is stored in memory 3204. The described computer program product may optionally be implemented in software modules loaded in memory 3204 and/or stored on a configured CD-ROM 3208 or storage unit 3209, thereby transforming the computer system in FIG. 32 to a special purpose machine for implementing the described system.

The I/O section 3202 is connected to keyboard 3205, display unit 3206, disk storage unit 3209, and disk drive unit 3207, typically by means of a system or peripheral bus (not shown). The system bus may be any of several types of bus structures including a memory bus or memory controller, a peripheral bus, and a local bus using any of a variety of bus architectures.

Generally, in contemporary systems, the disk drive unit 3207 is a CD-ROM drive unit capable of reading the CD-ROM medium 3208, which typically contains programs 3210 and data. Computer program products containing mechanisms to effectuate the systems and methods in accordance with the present invention may reside in the memory section 3204, on a disk storage unit 3209, or on the CD-ROM medium 3208 of such a system. Alternatively, disk drive unit 3207 may be replaced or supplemented by a floppy drive unit, a tape drive unit, or other storage medium drive unit. The network adapter 3211 is capable of connecting the computer system to a network via the network link 3212. In accordance with the present invention, software instructions directed toward accepting and relaying purchase orders using an intermittent connection to a merchandising database, a partial replica, or a client replica may be executed by CPU 3203, and merchandising data may be stored on disk storage unit 3209, disk drive unit 3207 or other storage medium units coupled to the system.

The drives and their associated computer-readable media provide nonvolatile storage of computer-readable instructions, data structures, program modules and other data for the computer 3213. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

The computer 3213 may operate in a networked environment using logical connections to one or more remote computers. These logical connections are achieved by a communication device 3211 (e.g., such as a network adapter or modem) coupled to or incorporated as a part of the computer 3213; the described system is not limited to a particular type of communications device. Exemplary logical connections include without limitation a local-area network (LAN) and a wide-area network (WAN). Such networking environments are commonplace in office networks, enterprise-wide computer networks, intranets and the Internal, which are all exemplary types of networks.

In an exemplary implementation, a tollgate site server, a tollgate customization tool, and interface modules may be incorporated as part of the operating system, application programs, or other program modules. The function-specific datastore and user account information may be stored as program data.

In one implementation, a tollgate site server can implement logic to determine which process tasks from multiple functional databases should be served up to a user in response to the user input. In an alternative implementation, a representation of the user input can be communicated to the database server for a functional database, and the database server can then determine which process tasks for the corresponding function are provided to the tollgate site server for display to the user.

FIG. 33 illustrates an exemplary set 3300 of questions and answers pertaining to a risk-based product. Answers are shown in rectangular boxes; questions are shown in rounded boxes. Responsive to selection of a risk-based product (see answer 3302), a wizard page is displayed to the user prompting for more detailed information useful in refining the project type determination. Likewise, FIG. 34 illustrates an exemplary set of questions and answers pertaining to a service based product, as indicated by answer 3402. These combinations of questions and answers may be used, for example, to define the appropriate project type. Based on this determination, logic can be applied to determine which process tasks should be performed for the project.

Given the user input received through a set of questions and answers, such as discussed with regard to FIGS. 33 and 34), a server (e.g., a tollgate site server or a database server) determined which process tasks are collected for the characterized project. Exemplary logic is shown below.
(1) If the user input satisfies the following logic, a process task tagged as “risk-based” is served up to the user.
Risk-based Product AND Reinsurance AND
   (In US Only OR Global OR In Non-US Only) AND
   (Mkt Ex Only OR All Products OR New Products Only)
(2) If the user input satisfies the following logic, a process task tagged as “risk-based” is served up to the user.
Risk-based Product AND Primary AND
   (In US Only OR Global OR In Non-US Only) AND
   (Mkt Ex Only OR All Products OR New Products Only)
(3) If the user input satisfies the following logic, a process task tagged as “service-based” is served up to the user.
Service-Based Product AND
   (In US Only OR Global OR In Non-US Only) AND
   (Mkt Ex Only OR All Products OR New Products Only)

Other process task may be selected by other user input combinations. For example, similar logic may be used to exclude from US-only projects with process tasks that are associated with global answers. Using such logic variations in one implementation, a total of 99 different project types may be characterized, although alternative logic resulting in greater or fewer than 99 different project types are also contemplated.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. In addition, data structures may be represented by individual objects, defined data structures, individual database tables, or combinations of associated database tables. A data field of a data structure may be represented or referenced by one or more associated database table fields.

The above specification, examples and data provide a complete description of the structure and use of exemplary embodiments of the invention. Since many embodiments of the invention can be made without departing from the spirit and scope of the invention, the invention resides in the claims hereinafter appended.

1. A method comprising:
receiving user input characterizing a project within a project management framework;
accessing at least one process task from each of a plurality of function-specific datastores, each function-specific datastore being associated with a functional area, each process task being associated with at least one process parameter; and
selecting a customized set of the process tasks from the plurality of function-specific datastores, each process task in the customized set being selected for the project if the at least one associated process parameter satisfies the user input.

2. The method of claim 1 wherein the operation of receiving user input comprises:
executing wizard to collect the user input.

3. The method of claim 1 wherein the operation of receiving user input comprises:
defining a project type that characterizes the project, based on the user input.

4. The method of claim 1 wherein at least one of the process tasks is further associated with a task parameter referencing a template useful in performing the process task.

5. The method of claim 1 wherein at least one of the process tasks is further associated with a task parameter referencing an example useful in performing the process task.

6. The method of claim 1 wherein at least one of the process tasks is further associated with a task parameter referencing a resource useful in performing the process task.

7. The method of claim 1 wherein at least one of the process tasks is associated with a process parameter associating the process task with one or more project types.

8. The method of claim 1 wherein the selecting operation comprises:
evaluating the user input with the at least one associated process parameter to determine whether the at least one associated process parameter satisfies the user input.

9. The method of claim 1 further comprising:
presenting the customized list of process tasks to the user in association with the project characterized by the user input.

10. The method of claim 1 wherein the function-specific datastore is managed by authorized personnel within the functional area.

11. The method of claim 1 wherein the user input characterizes a product.

12. The method of claim 1 wherein the user input characterizes a service-based product.

13. The method of claim 1 wherein the project involves introducing a new product.

14. The method of claim 1 wherein the project involves introducing a new service-based product.

15. The method of claim 1 wherein the project involves digitizing an existing product.

16. The method of claim 1 wherein the project involves moving a process into an international market.

17. A method comprising:
recording at least one process task and at least one associated process parameter in each of a plurality of function-specific datastores, each process task and associated process parameter being specified by a user authenticated to access the function-specific datastore; and
collecting from the function-specific datastores a customized set of process tasks for a project characterized by a project type, wherein the at least one process parameter associated with each process task in the customized set satisfies the project type of the project.

18. The method of claim 17 wherein at least one of the process tasks is further associated with a task parameter referencing a template useful in performing the process task.

19. The method of claim 17 wherein at least one of the process tasks is further associated with a task parameter referencing an example useful in performing the process task.

20. The method of claim 17 wherein at least one of the process tasks is further associated with a task parameter referencing a resource useful in performing the process task.

21. The method of claim 17 wherein at least one of the process tasks is associated with a process parameter associating the process task with one or more project types.

22. The method of claim 17 wherein the collecting operation comprises:
evaluating user input that characterizes the project with the project type with the at least one associated process parameter to determine whether the at least one associated process parameter satisfies the user input.

23. The method of claim 17 further comprising:
presenting the customized list of process tasks to the user in association with the project.

24. The method of claim 17 wherein the function-specific datastore is managed by authorized personnel within an individual functional area.

25. The method of claim 17 wherein the function-specific datastore is populated by authorized personnel within an individual functional area.

26. The method of claim 17 wherein the project involves introducing a new product.

27. The method of claim 17 wherein the project involves introducing a new service-based product.

28. The method of claim 17 wherein the project involves digitizing an existing product.

29. The method of claim 17 wherein the project involves moving a process into an international market.

30. A computer program product encoding a computer program for executing on a computer system a computer process, the computer process comprising:
receiving user input characterizing a project within a project management framework;
accessing at least one process task from each of a plurality of function-specific datastores, each function-specific datastore being associated with a functional area, each process task being associated with at least one process parameter; and
selecting a customized set of the process tasks from the plurality of function-specific datastores, each process task in the customized set being selected for the project if the at least one associated process parameter satisfies the user input.

31. The computer program product of claim 30 wherein the operation of receiving user input comprises:
executing wizard to collect the user input.

32. The computer program product of claim 30 wherein the operation of receiving user input comprises:
defining a project type that characterizes the project, based on the user input.

33. The computer program product of claim 30 wherein at least one of the process tasks is further associated with a task parameter referencing a template useful in performing the process task.

34. The computer program product of claim 30 wherein at least one of the process tasks is further associated with a task parameter referencing an example useful in performing the process task.

35. The computer program product of claim 30 wherein at least one of the process tasks is further associated with a task parameter referencing a resource useful in performing the process task.

36. The computer program product of claim 30 wherein at least one of the process tasks is associated with a process parameter associating the process task with one or more project types.

37. The computer program product of claim 30 wherein the selecting operation comprises:
evaluating the user input with the at least one associated process parameter to determine whether the at least one associated process parameter satisfies the user input.

38. The computer program product of claim 30 wherein the compute process further comprises:
presenting the customized list of process tasks to the user in association with the project characterized by the user input.

39. The computer program product of claim 30 wherein the function-specific datastore is managed by authorized personnel within the functional area.

40. The computer program product of claim 30 wherein the function-specific datastore is populated by authorized personnel within the functional area.

41. The computer program product of claim 30 wherein the user input characterizes a product.

42. The computer program product of claim 30 wherein the user input characterizes a service-based product.

43. The computer program product of claim 30 wherein the project involves introducing a new product.

44. The computer program product of claim 30 wherein the project involves introducing a new service-based product.

45. The computer program product of claim 30 wherein the project involves digitizing an existing product.

46. The computer program product of claim 30 wherein the project involves moving a process into an international market.

47. A computer program product encoding a computer program for executing on a computer system a computer process, the computer process comprising:
recording at least one process task and at least one associated process parameter in each of a plurality of function-specific datastores, each process task and associated process parameter being specified by a user authenticated to access the function-specific datastore; and
collecting from the function-specific datastores a customized set of process tasks for a project characterized by a project type, wherein the at least one process parameter associated with each process task in the customized set satisfies the project type of the project.

48. The computer program product of claim 47 wherein at least one of the process tasks is further associated with a task parameter referencing a template useful in performing the process task.

49. The computer program product of claim 47 wherein at least one of the process tasks is further associated with a task parameter referencing an example useful in performing the process task.

50. The computer program product of claim 47 wherein at least one of the process tasks is further associated with a task parameter referencing a resource useful in performing the process task.

51. The computer program product of claim 47 wherein at least one of the process tasks is associated with a process parameter associating the process task with one or more project types.

52. The computer program product of claim 47 wherein the collecting operation comprises:
evaluating user input that characterizes the project with the project type with the at least one associated process parameter to determine whether the at least one associated process parameter satisfies the user input.

53. The computer program product of claim 47 further comprising:
presenting the customized list of process tasks to the user in association with the project.

54. The computer program product of claim 47 wherein the function-specific datastore is managed by authorized personnel within an individual functional area.

55. The computer program product of claim 47 wherein the function-specific datastore is populated by authorized personnel within an individual functional area.

56. The computer program product of claim 47 wherein the project involves introducing a new product.

57. The computer program product of claim 47 wherein the project involves introducing a new service-based product.

58. The computer program product of claim 47 wherein the project involves digitizing an existing product.

59. The computer program product of claim 47 wherein the project involves moving a process into an international market.

60. A system comprising:
a user interface receiving user input characterizing a project within a project management framework;
a plurality of function-specific datastores, each function-specific datastore being associated with a functional area and storing at least one process task and an associated process parameter; and
a tollgate site server accessing at least one process task from each function-specific datastores and selecting a customized set of the process tasks from the plurality of function-specific datastores, each process task in the customized set being selected for the project if the at least one associated process parameter satisfies the user input.

61. The system of claim 60 wherein the user interface includes a wizard that collects the user input.

62. The system of claim 60 wherein the user input defines a project type that characterizes the project.

63. The system of claim 60 wherein at least one of the process tasks is further associated with a task parameter referencing a template useful in performing the process task.

64. The system of claim 60 wherein at least one of the process tasks is further associated with a task parameter referencing an example useful in performing the process task.

65. The system of claim 60 wherein at least one of the process tasks is further associated with a task parameter referencing a resource useful in performing the process task.

66. The system of claim 60 wherein at least one of the process tasks is associated with a process parameter associating the process task with one or more project types.

67. The system of claim 60 wherein tollgate site server evaluates the user input with the at least one associated process parameter to determine whether the at least one associated process parameter satisfies the user input.

68. The system of claim 60 wherein the user interface presents the customized list of process tasks to the user in association with the project characterized by the user input.

69. The system of claim 60 wherein the function-specific datastore is managed by authorized personnel within the functional area.

70. The system of claim 60 wherein the function-specific datastore is populated by authorized personnel within the functional area.

71. A system comprising:
a plurality of function-specific datastores, each function-specific datastore recording at least one process task and at least one associated process parameter, each process task and associated process parameter being specified by a user authenticated to access the function-specific datastore; and
a tollgate site server collecting from the function-specific datastores a customized set of process tasks for a project characterized by a project type, wherein the at least one process parameter associated with each process task in the customized set satisfies the project type of the project.

72. The system of claim 71 wherein at least one of the process tasks is further associated with a task parameter referencing a template useful in performing the process task.

73. The system of claim 71 wherein at least one of the process tasks is further associated with a task parameter referencing an example useful in performing the process task.

74. The system of claim 71 wherein at least one of the process tasks is further associated with a task parameter referencing a resource useful in performing the process task.

75. The system of claim 71 wherein at least one of the process tasks is associated with a process parameter associating the process task with one or more project types.

76. The system of claim 71 wherein tollgate site server evaluates the user input with the at least one associated process parameter to determine whether the at least one associated process parameter satisfies the user input.

77. The system of claim 71 wherein the user interface presents the customized list of process tasks to the user in association with the project characterized by the user input.

78. The system of claim 71 wherein the function-specific datastore is managed by authorized personnel within the functional area.

79. The system of claim 71 wherein the function-specific datastore is populated by authorized personnel within the functional area.

80. One or more computer-readable media storing a data structure comprising:
a first data field storing a process task definition associated with a first function; and
a second data field storing a process parameter associated with the first function, the process parameter associating the process task to one or more project types.

81. The one or more computer-readable media of claim 80 wherein the data structure further comprises:
a third data field storing a task parameter referencing a resource useful in performing the process task defined by the process task definition.

82. The one or more computer-readable media of claim 80 wherein the data structure further comprises:
a third data field storing a task parameter referencing a template useful in performing the process task defined by the process task definition.

83. The one or more computer-readable media of claim 80 wherein the data structure further comprises:
a third data field storing a task parameter referencing an example useful in performing the process task defined by the process task definition.

84. A server comprising:
a tollgate site server collecting a customized set of process tasks for a project characterized by a project type, each process task being associated with at least one associated process parameter, each process task and associated process parameter being specified by a user authenticated to define function-specific tasks, wherein the at least one process parameter associated with each process task in the customized set satisfies the project type of the project.

85. A user interface comprising:
a first display area receiving guided user input to characterize a project; and
a second display area displaying a customized set of process tasks for a project characterized by a project type, each process task being associated with at least one associated process parameter, each process task and associated process parameter being specified by a user authenticated to define function-specific tasks, wherein the at least one process parameter associated with each process task in the customized set satisfies the project type of the project.
